(19) United States
(12) Patent Application Publication
(10) Pub. No.: US 2011/0261823 A1
(43) Pub. Date: Oct. 27, 2011

(54) METHOD AND SYSTEM FOR MULTIPLEXING DATA STREAMING IN AUDIO/VIDEO NETWORKS

(75) Inventors: Harkirat Singh, Santa Clara, CA (US); Ilju Na, Suwon (KR); Jae Min Lee, Suwon (KR); Chiu Ngo, San Francisco, CA (US)

(73) Assignee: SAMSUNG ELECTRONICS CO., LTD., Suwon (KR)

(21) Appl. No.: 13/112,973

(22) Filed: May 20, 2011

Related U.S. Application Data
(63) Continuation-in-part of application No. 13/091,019, filed on Apr. 20, 2011.
(60) Provisional application No. 61/347,060, filed on May 21, 2010.
(60) Provisional application No. 61/326,961, filed on Apr. 22, 2010.

(51) Int. Cl. H04L 12/56

(52) U.S. Cl. 370/395.2; 370/395.1

(57) ABSTRACT

A method and system for communication in high speed audio/video networks. In one embodiment, communication between AV devices comprises establishing an AV path stream for AV data streaming between a source AV device and a destination AV device. Each AV device includes one or more I/O ports for connecting the AV device to another AV device via a communication link including multiple communication lanes. Asynchronous and isochronous AV data are multiplexed for transmission via one or more fixed length data cells, each data cell capable of carrying one or more of: asynchronous data symbols and isochronous data symbols. Isochronous data is mapped onto isochronous symbols in one or more data cells, Asynchronous symbols are mapped onto one or more data cells. One or more data cells are transmitted from a physical layer the source AV device to the destination AV device via one or more communication lanes.

### RELATED APPLICATIONS

This application is a continuation-in-part of U.S. patent application Ser. No. 13/091,019, filed on Apr. 20, 2011, which claims priority from U.S. Provisional Patent Application Ser. No. 61/326,961, filed on Apr. 22, 2010, both incorporated herein by reference. This application further claims priority from U.S. Provisional Patent Application Ser. No. 61/347,060, filed on May 21, 2010, incorporated herein by reference.

### FIELD OF THE INVENTION

The present invention relates in general to video transmission, and in particular, to isochronous video stream management in a high speed audio/video network.

### BACKGROUND OF THE INVENTION

Increasing quantity of multimedia content, and specifically high quality multimedia content, presents a number of communication and processing challenges to designers and administrators of computing platforms and networks alike. Video Electronics Standards Association (VESA), Digital Interactive Interface for Video and Audio (DiiVA), and HDBaseT Alliance provide industry-wide interface standards directed to unidirectional transport of high quality multimedia data between two electronic devices.

### BRIEF SUMMARY OF THE INVENTION

The present invention provides a method and system for communication in high speed audio/video networks. In one embodiment, communication between audio/video (AV) devices comprises establishing an AV path stream for AV data streaming between a source AV device and a destination AV device, wherein each AV device includes one or more I/O ports for connecting the AV device to another AV device via a communication link including multiple communication lanes. Said communication further comprises multiplexing asynchronous and isochronous AV data for transmission via one or more fixed length data cells, each data cell capable of carrying one or more of: asynchronous data symbols and isochronous data symbols. Multiplexing includes mapping isochronous data onto isochronous symbols in one or more data cells and mapping asynchronous data onto asynchronous symbols in one or more data cells. One or more data cells are transmitted from a physical layer the source AV device to the destination AV device via one or more communication lanes.

These and other features, aspects and advantages of the present invention will become understood with reference to the following description, appended claims and accompanying figures.

### BRIEF DESCRIPTION OF THE DRAWINGS

FIG. 1 shows a block diagram of a network of AV devices including a source audio/video (AV) device and a destination AV device, implementing isochronous data stream management for audio/video data communication, according to an embodiment of the invention.

FIG. 2 shows a block diagram of a network of AV devices including a source AV device, one or more bridge AV devices and a destination AV device, implementing isochronous data stream management for audio/video data communication by forwarding control messages from the source AV device to the sink (destination) AV device, according to an embodiment of the invention.

FIG. 3 shows isochronous data stream management for audio/video data communication by forwarding control messages from the sink AV device to the source AV device in the network of FIG. 2, according to an embodiment of the invention.

FIGS. 4A-4B show allocation of communication channel time for isochronous data stream management for audio/video data communication, according to an embodiment of the invention.

FIG. 5A illustrates a process for isochronous data stream management for audio/video data communication, according to an embodiment of the invention.

FIG. 5B shows a block diagram of an AV device isochronous data stream management for audio/video data communication, according to an embodiment of the invention.

FIG. 6A shows a block diagram of a network of AV devices including a source AV device, one or more bridge AV devices and a destination AV device, implementing isochronous data stream management for audio/video data communication by forwarding control messages from the source AV device to the sink (destination) AV device, according to an embodiment of the invention.

FIG. 6B shows isochronous data stream management for audio/video data communication by forwarding control messages from the sink AV device to the source AV device in the network of FIG. 6A, according to an embodiment of the invention.

FIG. 7 shows a video stream path setup request process in an AV network implementing isochronous data stream management for audio/video data communication, according to an embodiment of the invention.

FIG. 8 shows a video stream path setup response process in an AV network implementing isochronous data stream management for audio/video data communication, according to an embodiment of the invention.

FIG. 9 shows a process for AV data multiplexing communication between AV devices, according to an embodiment of the invention.

FIG. 10A shows data multiplexing processes in an AV transmitter device and an AV receiver device, according to an embodiment of the invention.

FIG. 10B shows data multiplexing by serial mapping AV data into data cells for transmission from an AV transmitter device to an AV receiver device, according to an embodiment of the invention.

FIG. 11 shows data multiplexing by parallel mapping AV data into data cells for transmission from an AV transmitter device to an AV receiver device, according to an embodiment of the invention.

FIG. 12 shows data multiplexing by serial mapping fragmented asynchronous data fragments data cells for transmission from an AV transmitter device to an AV receiver device, according to an embodiment of the invention.

FIG. 13 shows data multiplexing by parallel mapping fragmented asynchronous data into data cells for transmission from an AV transmitter device to an AV receiver device, according to an embodiment of the invention.

FIG. 14A shows a data streaming process implemented by an AV transmitter device, according to an embodiment of the invention.

FIG. 14B shows a data streaming process implemented by an AV receiver device, according to an embodiment of the invention.

FIG. 15 shows multiplexing by mapping asynchronous or isochronous data in a data cell, according to an embodiment of the invention.

FIG. 16 shows multiplexing multiple isochronous data streams for transmission from an AV transmitter to an AV receiver, according to an embodiment of the invention.

FIG. 17 is a high level block diagram showing an information processing system comprising a computer system useful for implementing an embodiment of the invention.

### DESCRIPTION OF THE INVENTION

Embodiments of the invention provide a method and system for flexible data multiplexing in a high speed multimedia network comprising multiple audio/video (AV) electronic devices. Embodiments of the invention provide a method and system for isochronous data stream management in multimedia networks such as high speed AV networks comprising multiple AV electronic devices. Embodiments of the invention further provide support for bi-directional transport of multimedia data comprising video data using a video path set-up scheme.

According to an embodiment of the invention, a forwarding table at each AV device is used to forward control messages including video path setup requests, and response messages, from a video source AV device to a video sink AV device. The video path setup requests are for allocation of isochronous communication resources such as lanes, their direction of data flow and symbols (or allocated channel time duration) on the selected lanes. Said isochronous resources are tracked in the forwarding table.

According to an embodiment of the invention, the port and lane for forwarding of a received control message is determined as needed, whereby a dedicated lane is not required for exchange of control messages. An allocation process reserves ports, lanes, and allocated channel time duration (or symbols) on the corresponding lanes. A port includes multiple lanes wherein a forwarding table entry for a particular destination device is in the form of a tuple of (port, lane). Lane assignment is dynamic and there is no dedicated port assigned for data/control communication. As such, the forwarding table includes the number of lane(s) over which data (e.g., packets) are communicated.

According to an embodiment of the invention, a device that is capable of supporting high speed video maintains forwarding information about the port and lane to which a control message, such as a video stream path setup request, should be transmitted on to reach a destination device. The forwarding information may be included as an array in the transmitted control message. The forwarding information may also be maintained in a forwarding table. In one embodiment, a device that is capable of supporting high speed video maintains a forwarding table for isochronous resource allocation including information about the video stream, port number, lane numbers, and channel time unit (or symbols) on the corresponding lane.

A dedicated channel for transmission of control messages is not required. A few port lanes may be selectively used in one direction such that the other remaining lanes on the port may be enabled in a different direction, wherein bi-directional flow of video content within a port is enabled.

According to an example implementation of the invention, a high-speed multimedia interface includes multiple ports. Each port may comprise, for example, one or more twisted pairs or lanes (e.g., physical data communication link or medium, a wireless link or medium). In one example, the number of twisted pairs is fixed to four. Each interface may provide a physical connection to enable bi-directional communication of multimedia traffic (compressed and uncompressed AV), control data and bulk data traffic.

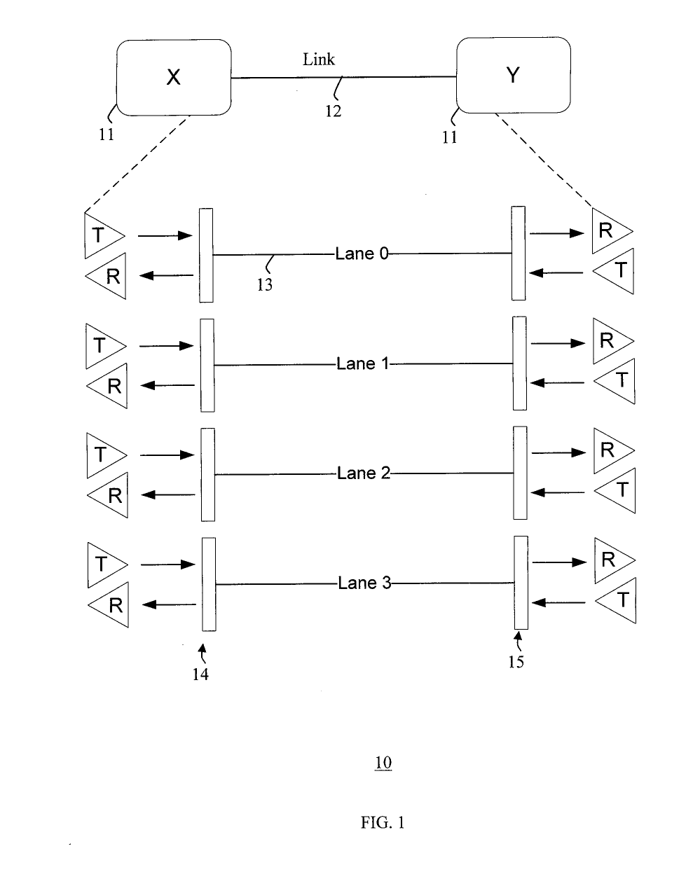

FIG. 1 shows a block diagram of a wired video network 10 comprising AV devices 11 (i.e., device X and device Y) connected via a wired communication link 12, according to an embodiment of the invention. The link 12 includes four physical lanes 13 (i.e., Lane 0, . . . , Lane 3) available on a port 14 of device X to a port 15 of device Y. In one example, each lane 13 can be configured either in Transmit (T) mode or in Receive (R) mode. In another example, each lane 13 may be in the T or R mode per packet basis, involving frequent mode changes of the physical (PHY) layer of each device.

An implementation of the first mode wherein each lane 13 can be configured either in Transmit (T) mode or in Receive (R) mode, is described hereinbelow, according to an embodiment of the invention.

### Bi-Directional Uncompressed Video and Audio Streaming

An example application of said high-speed multimedia is to bi-directionally transmit uncompressed video and audio data from a video source device (e.g., a DVD player) to a video sink device (e.g., a display device such as a television (TV)). In one embodiment of the invention, each lane 13 in FIG. 1 may support 5 Gbps, and total 20 Gbps for data communication over the four lanes. In order to provide bi-directional communication, at most 15 Gbps can be supported in one direction. In one example, video data can have a pixel size of 18, 24, 30, 36, or 48 bits, and video resolution supports VGA (640×480) to 1080p (1920×1080) depending on the display capabilities of the sink device.

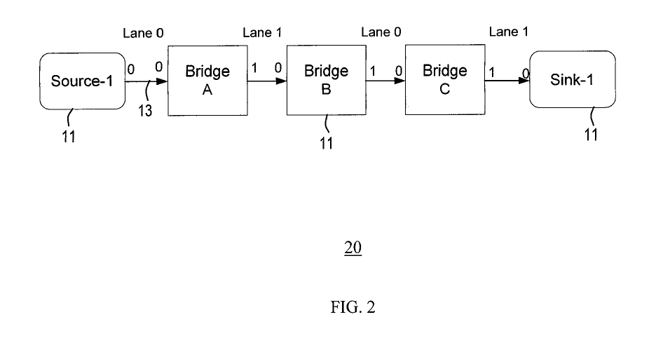

In one embodiment, the network 10 in FIG. 1 comprises a switched network that provide bi-directional support for AV streaming such that two out of the four lanes 13 are dynamically configured in the T mode and the other two lanes 13 are configured in the R mode such that simultaneous transmission of AV data between the devices X and Y is enabled. In one embodiment, in a multi-hop scenario such as illustrated by a switched network 20 of serially connected AV devices 11 shown in FIG. 2, there may be one or more switched AV bridge devices 11 connected to the source and sink AV devices 11, wherein both video and audio data from a source device are allowed to pass through the bridge devices 11 before reaching the sink device.

### Bulk Data Transfer

In FIG. 1, the lanes 13 used for transferring AV information may also be used for transferring large data files from the source device X to the sink device Y (e.g., destination device). This is achieved by multiplexing AV, control, and data over the lanes 13. For bulk data, USB or Ethernet data packets can be sent directly through the lanes 13. When USB or Ethernet protocol is not available, an application can send data as a generic data packet as well.

### Port, Lane, and Channel Time Allocation

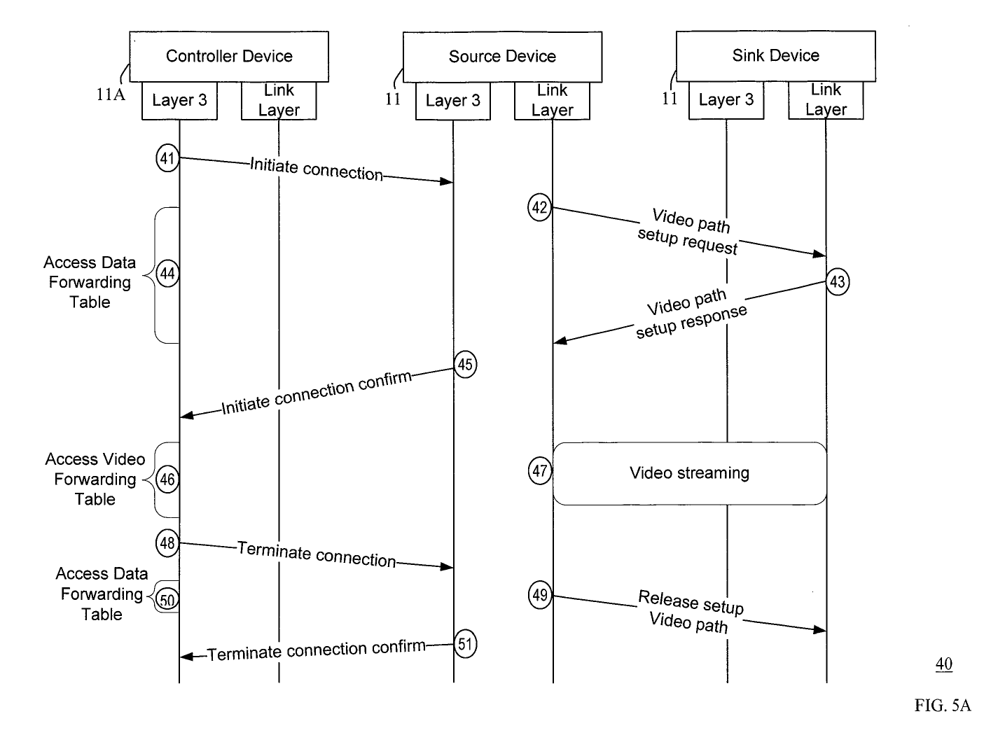

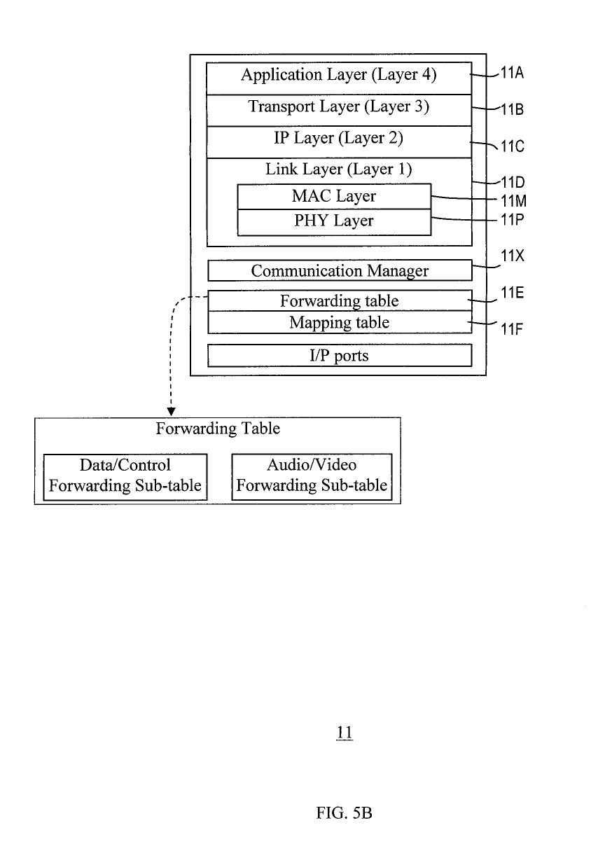

According to an embodiment of the invention, in a multi-hop scenario shown in FIG. 2, before a video data transmission is started, the source and the sink devices 11 negotiate using control messages including allocation messages for port, lane, and symbol time allocation (i.e., time unit or channel time allocation on a lane). The control messages are transmitted on the lanes 13 that are already assigned for the source and the sink devices for transmission of such control messages. In general, other information (e.g., frames/packets including compressed AV, Ethernet/USB frames, management frames, Layer 3 (e.g., FIG. 5B), and higher layer packets) may follow similar transmission rules as said control messages.

According to an embodiment of the invention, a Layer 2 forwarding table 11E (FIG. 5B) includes two sub-tables: data/control forwarding sub-table and audio/video forwarding sub-table (hereinafter video forwarding sub-table). The data/control forwarding sub-table includes information for forwarding of data/control information (data/control packets), and the video forwarding sub-table includes information for forwarding of audio/video data (e.g., uncompressed video data and audio data packets).

According to an embodiment of the invention, a forwarding table is constructed based on transparent bridging, namely forwarding, filtering, and flooding. In the AV network, an AV device discovers other devices that are reachable on a port by promiscuous listening. Because an AV device uses separate lanes for T and R modes, a different lane is used for transmission of its own frame than the lane used by a nearby AV device for the transmission of its frame. For a destination AV device that does not have an entry in the forwarding table, the received frame is forwarded on all other ports except the incoming port. In one embodiment, one lane is selected for the frame transmission out of several available lanes on a port. Each entry in the forwarding table may have a timer to age the entry and then to delete it from the forwarding table.

The video forwarding sub-table is dynamically updated based on control messages (e.g. video path setup request/response control messages), wherein the AV devices access their respective forwarding tables for AV data transmission. An AV forwarding table is dynamically updated based on control messages, wherein the AV devices access their respective data/control forwarding sub-tables for transmission of the AV data.

### Data and Control Message Forwarding

According to an embodiment of the invention, two options for data/control message forwarding are provided as described below.

Option 1: Array of Forwarding Port and Lane

According to Option 1, each control message includes an array of address fields wherein each address field includes a combination of port number and the lane number within the port, such as illustrated by Table 1 below.

TABLE 1
Array of Port and Lane Numbers

| Array Field 0 | | Array Field 1 | | Array Field 2 | | Array Field 3 | |
|---|---|---|---|---|---|---|---|
| | Lane | | Lane | | Lane | | Lane |
| Outbound | number on | Outbound | number on | Outbound | number on | Outbound | number on |
| Port | the Port | Port | the Port | Port | the Port | Port | the Port |
| 0 | 0 | 1 | 1 | 1 | 0 | 1 | 1 |

An AV device accesses the array in order to determine the port and lane for transmitting a control message. FIG. 2 shows an example control message flow from a source device Source-1 to a sink device Sink-1, wherein each port has at most four lanes. FIG. 2 illustrates information about outbound port, inbound port, and lane number within each port, wherein such information is included in the array of address fields. The example array of address fields in Table 1 above includes four fields for the considered topology in FIG. 2 when a control message traverses from the Source-1 to Sink-1 via the bridge devices 11 (i.e., Bridge A, Bridge B, Bridge C). Specifically, In Table 1, the Array Field 0 corresponds to Source-1, Array Field 1 corresponds to Bridge A, and so on. By accessing Array Field 0, the device Source-1 is informed that the outbound port is port 0 and the corresponding lane is Lane 0. By accessing Array Field 1, the device Bridge A is informed that the outbound port is port 1 and the corresponding lane is Lane 1. By accessing Array Field 2, the device Bridge B is informed that the outbound port is port 1 and the corresponding lane is Lane 0. By accessing Array Field 3, the device Bridge C is informed that the outbound port is port 1 and the corresponding lane is Lane 1.

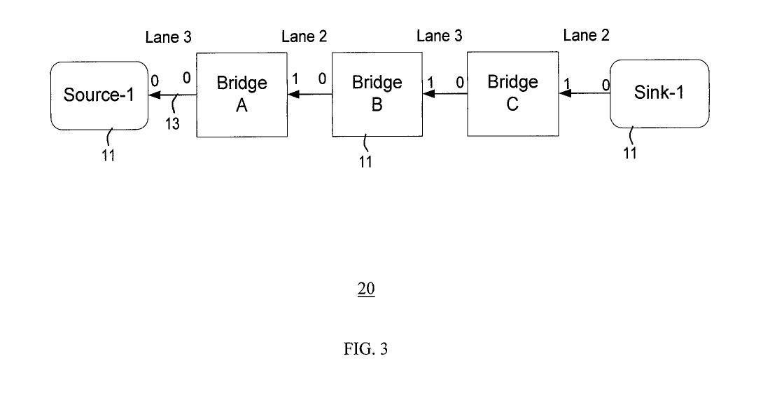

Similarly, when a control message traverses from device Sink-1 to device Source-1, the array of address fields may have different values corresponding to the network configuration shown in FIG. 3, using the array represented by Table 2 below, according to an embodiment of the invention.

TABLE 2
Array of Port and Lane Numbers

| Array Field 0 | | Array Field 1 | | Array Field 2 | | Array Field 3 | |
|---|---|---|---|---|---|---|---|
| | Lane | | Lane | | Lane | | Lane |
| Outbound | number on | Outbound | number on | Outbound | number on | Outbound | number on |
| Port | the Port | Port | the Port | Port | the Port | Port | the Port |
| 0 | 2 | 0 | 3 | 0 | 2 | 0 | 3 |

According to embodiments of the invention, the outbound port and lane number information can have different format than the arrays shown in Tables 1 and 2. For example, each array field may be a row of a matrix wherein the outbound ports and lane numbers become columns of the matrix. In this case the source device accesses the first row of the matrix, the next device accesses the second row of the matrix, and so on. A source device uses end-to-end information to populate the array fields, and each device on the multi-hop path accesses and modifies the array as needed.

In another embodiment, the forwarding table may have a default entry for lanes and port for outbound traffic. For example, within a port, default lanes are used for inbound and outbound traffic.

Option 2: Data/Control Message Forwarding Sub-Table

According to Option 2 for data/control message forwarding, in one embodiment, each device in the AV network 20 includes a data/control forwarding sub-table as a sub-table of the forwarding table 11E (FIG. 5B). A device can access its data/control forwarding sub-table based on the destination of an incoming control message from an upstream device, determine on which port and lane the control message should be transmitted to a downstream (i.e., peer) device. According to an embodiment of the invention, the data/control forwarding sub-table at AV devices in FIGS. 2 and 3 may include entries such as shown by example in Tables 3-7 below. In one implementation, each AV device may share information with its upstream (i.e., peer) device to inform the incoming port and lane for the upstream device. In another implementation, fixed lanes may be used for transmission of control messages.

TABLE 3
Data/control Forwarding sub-table at Source-1

| Destination | Outbound Port | Lane number on the Port |
|---|---|---|
| All destinations | 0 | 0 |

TABLE 4
Data/control Forwarding sub-table at AV Bridge Device A

| Destination | Outbound Port | Lane number on the Port |
|---|---|---|
| Source-1 | 0 | 3 |
| B, C, Sink-1 | 1 | 1 |

TABLE 5
Data/control Forwarding sub-table at AV Bridge Device B

| Destination | Outbound Port | Lane number on the Port |
|---|---|---|
| Souce-1, A | 0 | 2 |
| C & Sink-1 | 1 | 0 |

TABLE 6
Data/control Forwarding sub-table at AV Bridge Device C

| Destination | Outbound Port | Lane number on the Port |
|---|---|---|
| Souce-1, A, B | 0 | 3 |
| Sink-1 | 1 | 1 |

TABLE 7
Data/control Forwarding sub-table at Sink-1

| Destination | Outbound Port | Lane number on the Port |
|---|---|---|
| All destinations | 0 | 2 |

### Mapping Table

According to an embodiment of the invention, video data transmission involves end-to-end resource allocation (e.g., ports, lanes, communication link channel time) between a source device and a sink device. For example, in FIG. 2, Source-1 to Sink-1 video data transmission requires allocation of ports, lanes, and channel time. The various ports and lanes may be dynamically configured, such that the resource allocation enables configuration of lanes in terms of T and R modes described above. Moreover, the channel time on a lane may be multiplexed among multiple streams. In this way, the channel time on each lane can be shared among multiple streams.

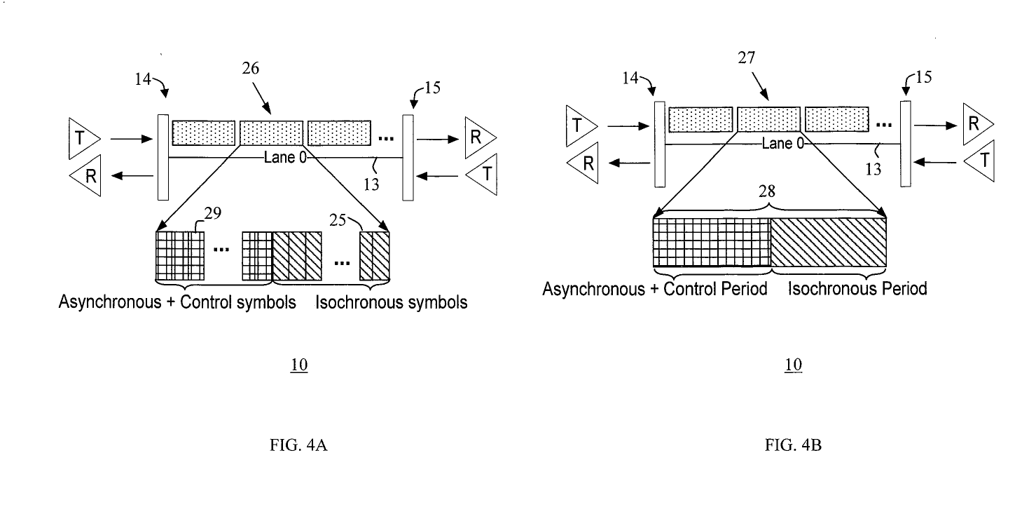

Referring to FIG. 4A, according to an embodiment of the invention, channel time may be divided into units for transmission of multiple fixed length packets. In such a case, channel time is allocated in terms of asynchronous control symbols 29, and isochronous symbols 25 within such fixed length packets 26 (e.g., transport packets), for isochronous channel time. FIG. 4A shows the case of channel time for isochronous streams in terms of symbols 25 within a transport packet. According to an embodiment of the invention, channel time may be represented as a contiguous contention free period 28 on the channel, as shown by example in FIG. 4B, illustrating isochronous channel time allocation. FIG. 4B shows superframe based time allocation, wherein each superframe 27 that occurs on a periodic basis, includes contention free periods 28. Each period 28 comprises an asynchronous control period and an isochronous period. Only activity on Lane 0 is illustrated in FIGS. 4A-4B, however, other lanes existing on a port may follow the same implementation.

According to an embodiment of the invention, in an AV network the source device 11 (e.g., Source-1) is preferred to initiate a video path setup request (control message) as it has accurate information about the bandwidth requirement of an isochronous stream. The video path setup request includes a stream or sequence number to distinguish different video path setup requests generated by the source device. In one embodiment, the stream or sequence number may be maintained as a 16-bit or 32-bit counter in the source device such that each new video path setup request initiated by the source device has a different value. Each AV device 11 in the video network maintains the stream index that can be represented as a combination of {Source address, Destination address, media access control (MAC) address of the device initiating the video-path-setup request, and stream number or sequence number}, wherein MAC comprises medium access control information. Based on these values, each AV device 11 can distinguish between different stream indices. The stream index is a local variable in each AV device that is not shared with other AV devices in the AV network. According to an embodiment of the invention, a mapping table 11F (FIG. 5B) may be used for maintaining the stream index, as shown by example Table 8 below.

TABLE 8
Mapping Table

| | Isochronous Stream Details (from the control message) | | | |
|---|---|---|---|---|
| | | | | Sequence |
| | | Desti- | MAC address of the | number or |
| Stream | Source | nation | device initiated the | stream |
| Index | Address | Address | video_path_setup_Request | number |
| a | X | Y | X | n |
| b | U | R | R | k |
| . . . | . . . | . . . | . . . | . . . |

Further, as shown by the example Table 9 below, a mapping table for an AV device (i.e., devices 11 in FIG. 2) may have entries based on Source-1 initiating a video-path-setup request and setting the sequence or stream number field set to S.

TABLE 9
Mapping Table

| | Isochronous Stream Details (from the control message) | | | |
|---|---|---|---|---|
| | | | | Sequence |
| | | Desti- | MAC address of the | number |
| Stream | Source | nation | device initiated the | or stream |
| Index | Address | Address | video_path_setup_Request | number |
| 0 | Source-1 | Sink-1 | Source-1 | S |

### Video Forwarding Sub-Table

According to an embodiment of the invention, a video forwarding sub-table at each AV device includes information for forwarding of uncompressed audio/video data messages (packets) between AV devices in the AV network. Example video forwarding sub-tables 10-13 below illustrate allocated resources at various AV devices in the network shown in FIG. 2. For illustration purposes it is assumed that embodiments of the invention make use of symbol based bandwidth allocation as in FIG. 4A.

TABLE 10
Video Forwarding sub-table indicating resource allocation at Source-1

| | | Lane number | |
|---|---|---|---|
| Stream Index | Outbound Port | on the Port | Allocated TU |
| i | 0 | 0 | Symbols j |
| | | | 1 . . . N symbols are |
| | | | free for allocations, j, |
| | | | k, m < N |
| | | 2 | Symbols k |

TABLE 11
Video Forwarding sub-table indicating resource
allocation at AV Bridge Device A

| Stream Index | Outbound Port | Lane number on the Port | Allocated TU |
|---|---|---|---|
| i | 1 | 1 | Symbols j |
| | | 3 | Symbols k |

TABLE 12
Video Forwarding sub-table indicating resource
allocation at AV Bridge Device B

| Stream Index | Outbound Port | Lane number on the Port | Allocated TU |
|---|---|---|---|
| i | 0 | 0 | Symbols j |
| | | 2 | Symbols k |

TABLE 13
Video Forwarding sub-table indicating resource
allocation at AV Bridge Device C

| Stream Index | Outbound Port | Lane number on the Port | Allocated TU |
|---|---|---|---|
| i | 1 | 0 | Symbols m |

Similarly, other AV devices on the video path between Source-1 and Sink-1 maintain inbound information in the video forwarding sub-table.

FIG. 5A illustrates an AV network including an AV device, a sink AV device, and a controller module/device. According to embodiments of the invention, the controller module/device may be a separate AV device (as shown), or a maybe a component of one of the AV devices (such as the source device or the sink device). In one embodiment, an AV device may comprise a consumer electronic device, a personal computer, a mobile device, etc., referred herein collectively as an AV device. Each such AV device may comprise one or more of: a communication manager including a multiplexing module, a communication module, a connection set-up module, a stream management module, processor, memory, input/output ports, display monitor, user interface, etc. The AV devices may be connected via a network of wired communication links comprising (physical) lanes selectively connected between ports of the devices.

Referring to the block diagram in FIG. 5B, one embodiment an AV device (e.g., AV devices 11) comprises an Application Layer (Layer 4) 11A including processes that use the network, a Transport or TCP Layer (Layer 3) 11B including processes that provide end-to-end data delivery, an IP Layer or Network/Internet Layer (Layer 2) 11C including processes handling routing of data, and a Link Layer comprising physical and data link sub-layers (Layer 1) 11D including processes for accessing physical communication medium. These layers are similar to TCP/IP layers which can be loosely mapped to the Open System Architecture (OSI). The data link sub-layer of the Link Layer includes a MAC Layer 11M and a PHY Layer 11P, configured for communication over an AV wired network, according to embodiments of the invention. Further, a communication manager 11X including a multiplexing module, implements multiplexing for data communication between AV devices the AV network.

FIG. 5A further illustrates a video stream path setup process according to an embodiment of the invention. In process block 41, isochronous video stream connection set up begins when a stream controller device 11A transmits an Initiate connection control message that may be transmitted over Layer 3 (FIG. 5B). Upon receiving the Initiate connection control message, in process block 42 a Source device in turn sends a Video path setup request control message to a sink device. Video path setup related control messages include various fields such as: {source address, destination address, Sequence number/stream number, Request Bandwidth Request, Time To Live (TTL), etc.}. In process block 43, the Sink device sends a Video path setup response control message to the Source device. The response indicates if the video path setup request is successful and the reason if the video path setup request failed. In process block 44, the controller device accesses a data/control forwarding sub-table (FIG. 5B) to determine forwarding information for the control message. In process block 45 the Source device sends an Initiate connection confirmation control message to the controller device.

Once a video stream is established, in process block 46 a video forwarding sub-table is accessed for switching and forwarding of uncompressed video data. In process block 47, each AV device can appropriately forward received video data on a corresponding port and lane to its downstream device. In one embodiment, the uncompressed video frames do not contain source and destination addresses such that the received video data is correctly forwarded on the downstream port based on the video forwarding sub-table. The video forwarding sub-table entries remain valid until a video-path setup control message with the matching sequence number is received to delete the allocation.

In process block 48, the controller device terminates the connection by sending a Terminate connection control message on Layer 3 (FIG. 5B), that is followed in process block 49 by a Layer 2 (FIG. 5B). Release setup video path control message from the Source device to release the allocated resources for the video stream. In process block 50 a data/control forwarding sub-table is accessed to determine forwarding of the control message and in process block 51 the source device sends a Terminate connection confirmation control message to the controller device. In one embodiment, the data/control forwarding sub-tables (e.g., Tables 3-7 above) are used to determine the outbound port and lanes based on the destination address in the control messages for forwarding control messages.

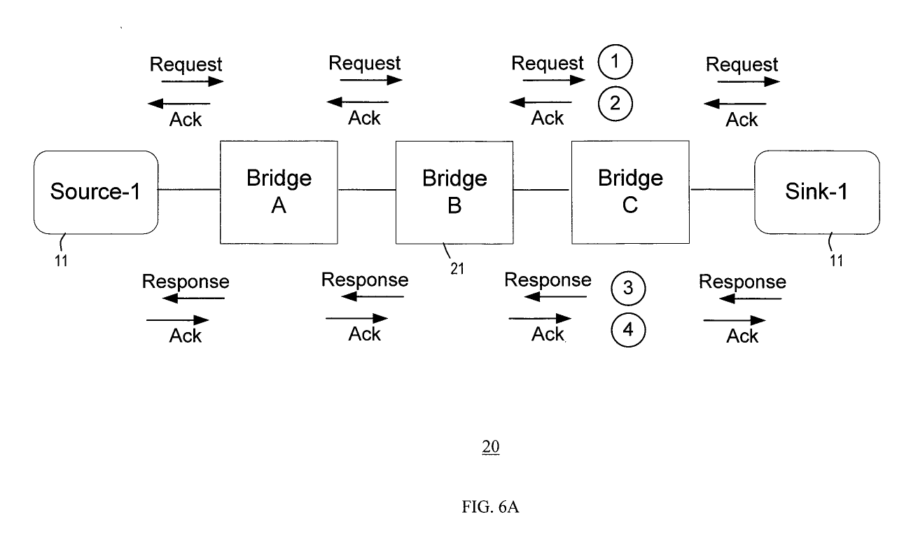

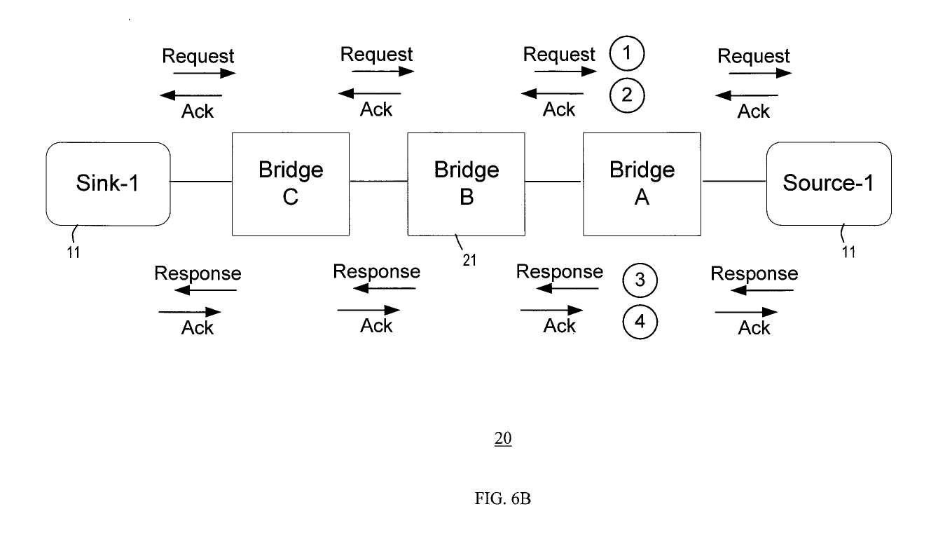

FIG. 6A shows an example video path setup request and response control message sequence in the AV network 20 based on the above process 40 for video transmission from Source-1 to Sink-1, according to an embodiment of the invention. As shown in FIG. 6A, before a forwarding AV device (e.g., Bridge B) forwards a video path setup request control message from an upstream (previous hop) AV device (e.g., Bridge A) to a downstream (next hop) AV device (e.g., Bridge C), the forwarding AV device determines if a requested video transmission bandwidth can be satisfied. If the requested bandwidth can satisfied, then the forwarding AV device sends an acknowledgment (Ack) control message to the upstream AV device. Otherwise, the forwarding AV device sends a Nack (i.e., not Ack) control message to its upstream AV device that eventually reaches the source device (e.g., Source-1), as illustrated in FIG. 6A. The Nack message may optionally include an alternative suggested bandwidth that is lower than the originally requested one.

Once the request control message successfully reaches the destination device (e.g., Sink-1), a response control message is transmitted back to the source device. The response message is forwarded hop-by-hop starting from the destination device, as illustrated in FIG. 6A. In one example, Source-1 that initiates a video-path setup request control command and Sink-1 is the device that initiates the video-path setup response control command. AV bridges devices A, B, and C participate in forwarding the setup request and response control messages. On each AV device, the response message is replied with an Ack message that includes the outbound port resource allocation on the AV device that transmitted the Ack message.

The AV device that transmitted the video setup response control message upon receiving the resource allocation embedded in the Ack response control message, updates its video forwarding sub-table for both inbound and outbound ports related to the video stream. As discussed above, the stream index field is not shared with a peer AV device and instead the detailed mapping fields such as {Source address and Destination address, (address of the device that initiated the video-path-setup request & sequence/stream number)} are used. FIG. 6A illustrates the sequence of control messages 1, 2, 3, and 4 between devices B and C when both the request and response control messages are successful.

Similarly, FIG. 6B shows an example video path setup request and response control message sequence in the AV network 20 based on the above process 40 for video transmission from Sink-1 to Source-1, according to an embodiment of the invention. As such, FIGS. 6A-6B illustrate bi-directional video transmission between source and sink AV devices according to embodiments of the invention.

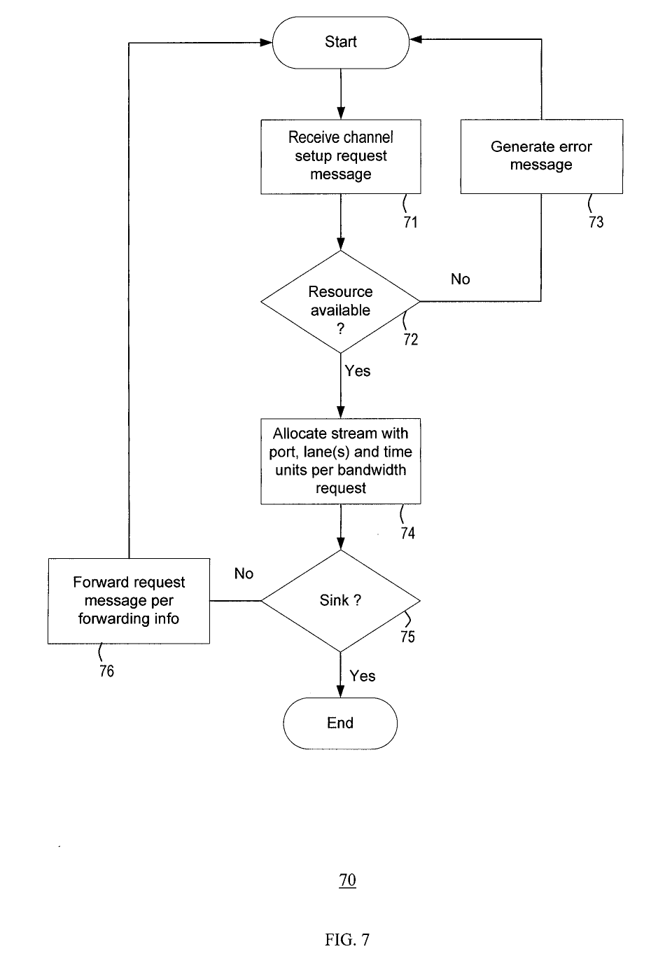

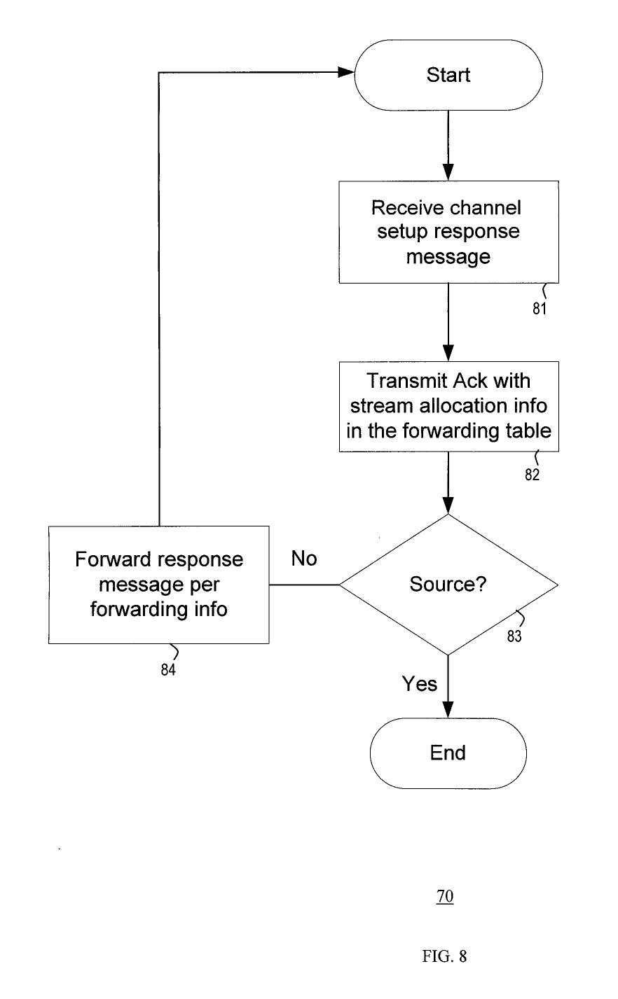

Referring to processes in FIGS. 7-8, a video stream path from a source AV device to a destination (sink) AV device is established via the lanes 13 between the AV devices in the AV network, according to an embodiment of the invention. FIG. 7 shows a video stream path setup request process 70 in an AV network, according to an embodiment of the invention. In process block 71, a request control message comprising a channel setup request to setup an AV stream is received from an upstream AV device. In process block 72, it is determined if resources (e.g., port, lane(s) time units per the bandwidth request) to satisfy a requested stream bandwidth are available. If sufficient resources are not available, in process block 73 a response error message is generated and the process proceeds to block 71. If sufficient resources are available, in process block 74 resources are allocated. In process block 75, if the recipient of the channel setup request control message is a destination (sink) AV device, then the process terminates, otherwise in process block 76 the request control message is forwarded to a downstream AV device using data/control forwarding sub-table information. A video stream path setup response process corresponding to the above video stream path setup request process is described below.

FIG. 8 shows a video stream path setup response process 80 in an AV network, according to an embodiment of the invention. In process block 81, a channel setup response control message is generated in response to a video path setup request control message received from an upstream AV device. In process block 82, an Ack control message including video stream allocation information from a data/control forwarding sub-table is transmitted to the upstream AV device. In process block 83, if the receiving AV device is a source AV device, the process terminates. Otherwise, in process block 84, the response control message is sequentially forwarded to upstream AV devices in the video stream path based on forwarding information in respective data/control forwarding sub-table of each AV device in the path. As such, embodiments of the invention provide a method and system for establishing a video path that is bi-directional between physical ports of two AV devices, wherein AV data can travel bi-directionally (i.e., in opposite directions) on a communication link between two AV devices for isochronous data stream management in AV networks.

In another embodiment, the invention provides a method and system for flexible data multiplexing in a high speed multimedia network comprising multiple audio/video (AV) electronic devices. For example, the AV network 20 in FIG. 2 may implement a Room-to-room Unified Bi-directional Interface (RUBI) comprising switched AV bridge devices 11 (e.g., RUBI Devices A, B, C) serially connected with an AV source device 11 and an AV sink device 11, according to an embodiment of the invention. Each AV device 11 has a unique MAC address referred as RUBI Device Address (RDA). An AV port supports multiple lanes as shown in FIG. 1. In one embodiment of the invention, multiple stream source modules (e.g., Stream Src-0, Stream Src-1, etc.) may be included in an AV source device and/or multiple stream sink modules (e.g., Stream Sink-0, Stream Sink-1, etc.) available may be included in an AV sink device.

An implementation of the invention wherein each lane can be configured either in Transmit (T) mode or in Receive (R) mode, is described hereinbelow. A frame structure is used for data transmission between a transmitting AV device (i.e., AV transmitter) and a receiving AV device (i.e., AV receiver). In a transmitter, a MAC layer receives a MAC Service Data Unit (MSDU) and attaches a MAC header thereto, in order to construct a MAC Protocol Data Unit (MPDU). The MAC header includes information such as a source address (SA) and a destination address (DA). The MPDU is a part of a PHY Service Data Unit (PSDU) and is transferred to a PHY layer in the transmitter to attach a PHY header (i.e., a PHY preamble) thereto to construct a PHY Protocol Data Unit (PPDU). The PHY header includes parameters for determining a transmission scheme including a coding/modulation scheme.

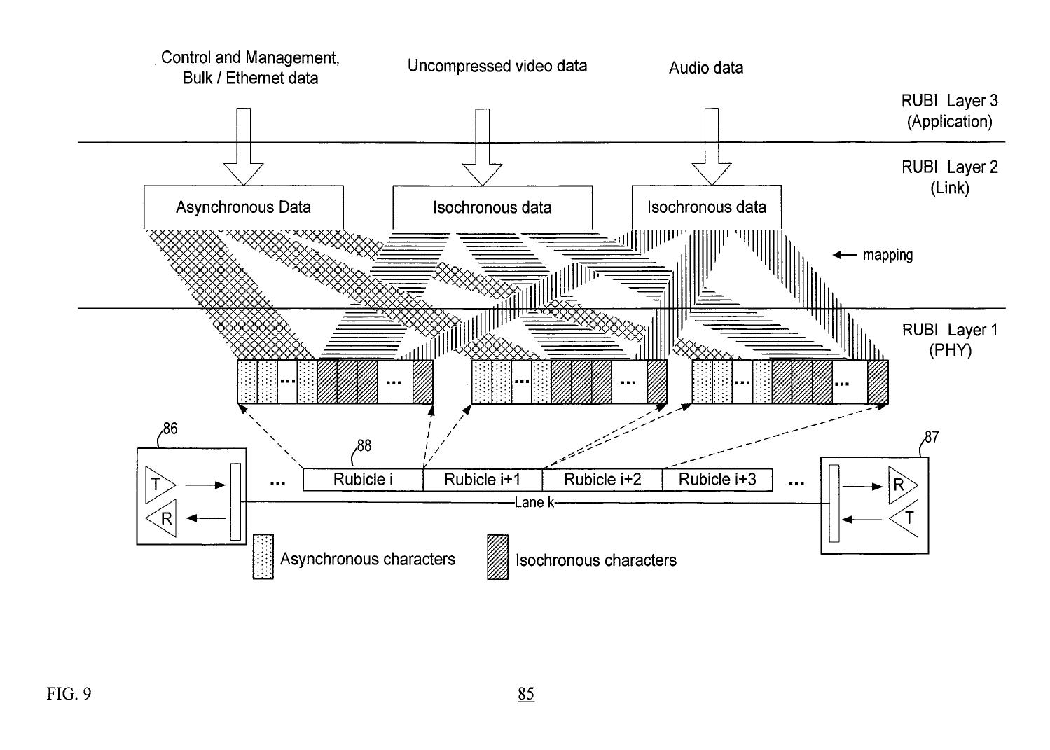

Referring to FIG. 5B, the Link control layer (i.e., Layer 1) and the PHY layer are utilized wherein in an AV transmitter, Link Layer receives a Link Service Data Unit (LSDU) from higher layers and attaches a Layer 2 (i.e., RUBI L2 or LLC) header thereto, in order to construct a Link Protocol Data Unit (LPDU). The RUBI L2 header includes information such as a source address (SA) and a destination address (DA). The LPDU is a part of a PHY Service Data Unit (PSDU) and is transferred to a PHY layer in the transmitter to attach a PHY header, scrambling and encoding thereto to construct a PHY Protocol Data Unit (PPDU). The PHY header includes parameters for determining a transmission scheme including a coding/modulation scheme. In FIG. 5B, Layer 1 includes MAC and PHY layers, which are shown separately in FIG. 9.

According to an embodiment of the invention, the AV transmitter PHY layer in configured to continuously transmit a fixed length of N-character data units referred to herein as Rubicles. Each Rubicle comprises a N-character data cell that may contain a combination of zero or more asynchronous and/or isochronous characters (symbols). As such, each Rubicle that is transmitted may contain no asynchronous or isochronous characters, or it may contain one or more asynchronous and/or isochronous characters. Isochronous data is mapped onto isochronous characters and asynchronous data is mapped onto asynchronous characters in one or more Rubicles. Embodiments of the invention allow multiplexing of such asynchronous and isochronous characters for isochronous data streaming in an AV network. In one example, a PHY communication channel is represented as a continuous flow of N-character long Rubicles. The mapping of a PPDU, carrying asynchronous data, at the RUBI PHY may follow either Serial or Parallel mapping mode. According to an embodiment of the invention, the mapping of the PPDU is implemented at the PHY layer of a transmitting AV device (such utilizing a mapping module), and reconstruction of PPDU is implemented at the PHY later of a receiving AV device (such as using a reconstruction module).

In the Serial mapping mode, a new PPDU is mapped to Rubicles on all available lanes in a round-robin fashion, starting from the first available Rubicle on a lane. A lane that is not available is skipped. In the Parallel mode, a new PPDU is mapped to Rubicles on the next available lane such that all fragments of the PPDU are then mapped to the same lane. As such, multiple PPDUs can be served (or mapped to the Rubicles) in parallel. In the Serial mapping mode, a PPDU can not be served while the PPDU currently mapped is not completed. In either mode, a RUBI L2 header is not repeated for each PPDU.

A Rubicle is utilized for multiplexing of asynchronous and isochronous data within a single Rubicle. According to embodiments of the invention, packet-based asynchronous data is utilized wherein a PPDU is fragmented across multiple Rubicles for transmission from an AV transmitter to an AV receiver over a communication link. Embodiments of the invention support asynchronous data transmission without increasing AV device FIFO (first-in-first-out) buffer size because multiple isochronous data streams are simultaneously multiplexed. The isochronous streams are continuously transmitted without buffering. Any unused characters in Rubicles are dynamically used for asynchronous data, which further lowers buffering at the AV transmitter. Embodiments of the invention further provide flexible multiplexing of asynchronous and isochronous data to improve the overall system efficiency, and support asynchronous data without a dedicated communication channel over the communication links.

In one embodiment, the present invention provides character (symbol)-based multiplexing wherein Rubicles are of a fixed length. As such, even in the absence of any asynchronous or isochronous data, packets are continuously transmitted. Said RUBI L2 header is only used in the very first PPDU fragment, and subsequent PPDU fragments do not carry the RUBI L2 header. One MSDU is fragmented across multiple PPDUs without the need for indication bits in the PPDU or MPDU.

FIG. 9 illustrates a process 85 for multiplexing of asynchronous and isochronous data between AV devices such as an AV transmitter 86 and an AV receiver 87 (in an AV network such as network 20 in FIG. 2), according to an embodiment of the invention. Management and control data pertaining to the RUBI link layer (Layer 2 or L2) and the application layer (Layer 3 or L3) are also multiplexed with AV data. A communication lane (e.g., lane k) that is configured for the data flow direction to be in the Transmit mode, continuously transmits a fixed length of N-character units a Rubicle 88. Each Rubicle 88 comprises a data cell including zero or more asynchronous and isochronous characters. In each Rubicle 88, isochronous data is mapped onto isochronous characters and asynchronous data is mapped onto asynchronous characters, as shown in FIG. 9. Each character carries a fixed amount of data. In one embodiment of the invention, one character may carry 10-bit if 8b/10b coding is used. Rubicles 88 are continuously transmitted irrespective of presence or absence of isochronous or asynchronous data therein.

In one embodiment, isochronous data is reserved using a stream/path set-up scheme. Therefore, in a Rubicle 88 reserved characters belong to isochroous data or stream. As shown in FIG. 9, reserved characters in a Rubicle are mapped to isochronous data belonging to uncompressed video and audio data. Such isochronous data may belong to multiple sources and multiple destinations thus allowing multiplexing of multiple isochronous streams within a single Rubicle 88. Within a Rubicle 88, the unreserved characters may be mapped to asynchronous data as shown in FIG. 9.

In one implementation, asynchronous data and isochronous data (generated by Layer 3) are mapped to the fixed length Rubicles 88. The location of isochronous characters in a Rubicle 88 is determined by accessing an isochronous forwarding table (e.g., stored in Layer 2) that indicates reserved characters for isochronous streams. Asynchronous characters are unreserved characters in a Rubicle 88 onto which asynchronous data is mapped. In one implementation, all unreserved characters (asynchronous characters) and all reserved characters (isochronous characters) in a Rubicle 88 can be sub-grouped such that the asynchronous characters appear first followed by the isochronous characters.

### Processing of Asynchronous Data

An example of mapping and processing of asynchronous data at an AV transmitter (such as an AV source) and an AV receiver (such as an AV sink) according to an embodiment of the invention, is now described.

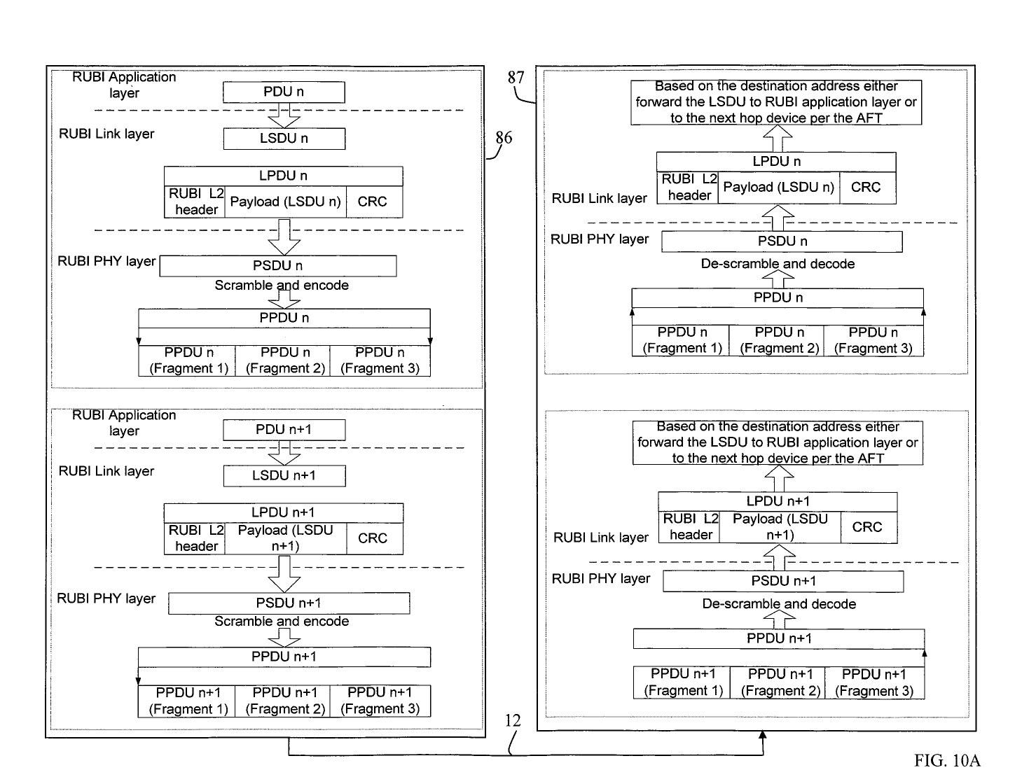

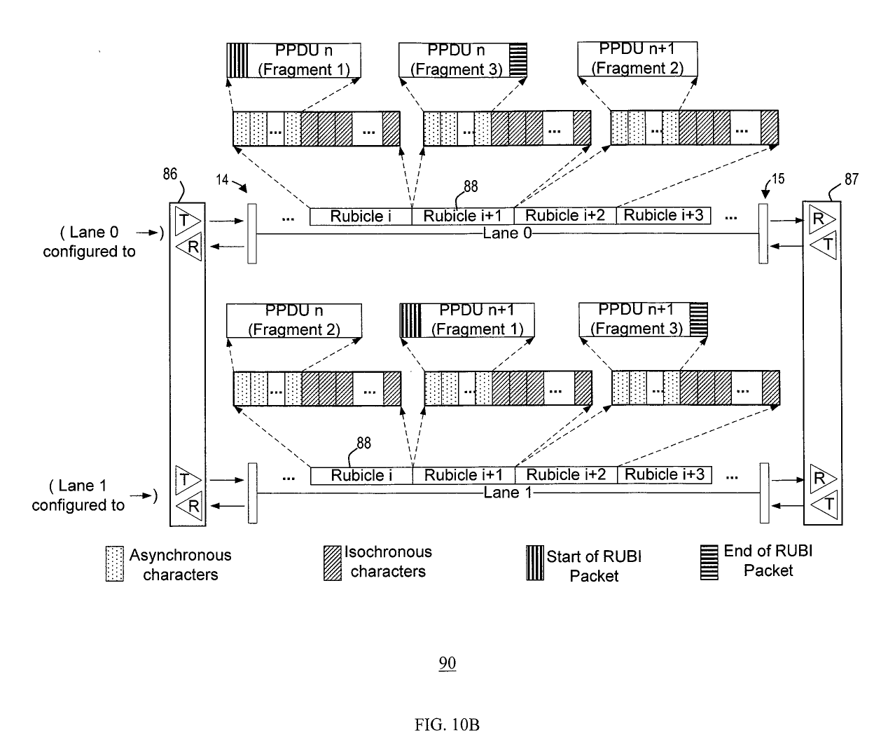

Referring to the AV transmitter 86 in FIG. 10A and process 90 in FIG. 10B, according to one embodiment of the invention, an AV transmitter operation comprises the following:
1. At the AV transmitter 86, the Application Layer sends a Protocol Data Unit (e.g., PDU n) to the Link Layer.
2. The Link Layer receives a Link Service Data Unit (e.g., LSDU n).
3. The Link Layer forms Link Protocol Data Unit (e.g., LPDU n) by:
   (i) Appending a RUBI L2 header to the LSDU.
      The RUBI L2 header includes the following fields:
         The source address (SA) and destination address (DA) fields that carry RUBI Device Addresses of the transmitter (e.g., AV source) and receiver (e.g., AV sink), respectively.
         Type field that indicates the type that is set to Ethernet, control, management, etc.
         Length field indicating the length of the LSDU.
         Sequence number field.
         Fragment control field to indicate the fragment when the LSDU cannot fit into one single LPDU.
         Retry control field to allow retransmission of the LPDU.
         Time To Live (TTL) to disallow further propagation of the LPDU when the TTL limit is reached.
         Other flags.
   (ii) Appending cyclic redundancy check (CRC) to the RUBI L2 header and the LSDU.
   (iii) Adding padding bits as necessary.
4. The resulting LPDU is forwarded to the PHY Layer.
5. The PHY Layer processes a received PHY Service Data Unit (i.e., PSDU n) by adding redundancy and/or scrambling the bits to handle any channel impairments.
6. A resulting PHY Protocol Data Unit (e.g., PPDU n) is mapped to asynchronous characters in Rubicles 88 as shown in FIG. 10B, which further illustrates packet transmission over multiple lanes (e.g., Lane 0, Lane 1) on a communication link 12 between the AV transmitter 86 and the AV receiver 87. The mapping of the PPDU includes first inserting “Start of RUBI Pkt (SR)” control character to the PPDU data (i.e., the SR characters is first transmitted before transmitting the first character of the PPDU). The end of the PPDU is signaled by inserting “End of RUBI Pkt (ER)” control character after the last character of the PPDU. In case the PPDU cannot fit into asynchronous characters on a single Rubicle 88, the PPDU is mapped onto multiple Rubicles 88. In this case, optionally in one embodiment, “Continue of RUBI Pkt (CR)” is inserted when the PPDU is fragmented among multiple Rubicles. The SR control character can appear anywhere in a Rubicle as the first asynchronous character, middle asynchronous character or last. The CR control character can appear as the first asynchronous character in a Rubicle 88. The ER control character appears as the first asynchronous, middle asynchronous or the last asynchronous character in a Rubicle 88.

Referring to the AV receiver 87 in FIG. 10A and process 90 in FIG. 10B, according to one embodiment of the invention, an AV receiver operation comprises the following:
1. A PPDU is reconstructed by collecting asynchronous characters between the SR and ER control characters in received packets.
2. The PPDU is descrambled and decoded at the PHY Layer to recreate the original PSDU.
3. The PSDU is forwarded to the Link Layer.
4. The Link Layer checks the CRC to detect any errors, and correct as needed.
5. The Link layer either forwards the LSDU to the application if the destination address of the RUBI L2 header matches with the receiver RUBI L2 address, otherwise, the LPDU is forwarded to the next hop device (i.e., a bridge AV device in FIG. 2) based on a Asynchronous Forwarding Table (AFT) at the AV receiver. The AFT indicates the outbound {Port and Lane} for the DA device in the RUBI L2 header.

At the AV transmitter, the mapping of a PPDU at the PHY Layer may be either Serial or Parallel mapping mode. In the serial mode, a new PPDU is mapped to Rubicles on all available lanes in a circular manner, starting from the first available Rubicle on a Lane. In this mode only one PPDU can be serviced at a given instant. Once the PPDU is transmitted, the transmission of the next PPDU can begin. In the Parallel mode, a new PPDU is mapped to Rubicles on the next available lane such that all fragments of the PPDU are then mapped to the same lane. Therefore, more than one PPDU can be serviced concurrently in time-domain.

FIGS. 10A-B show a serial mapping of asynchronous data, according to an embodiment of the invention. Specifically, FIGS. 10A-B illustrate serial mapping of PPDUs belonging to asynchronous data. In one example, a RUBI port 14 comprises K lanes, however, only two lanes are configured in the Transmit mode for the flow of direction shown in FIG. 10B. In one example, mapping of PPDU n at the AV transmitter comprises forming PPDU n by first sending the Application Layer PPDU n to the Link Layer. The resulting LSDU n is transferred into the LPDU n by adding RUBI L2 header and CRC fields as described above. The Link Layer then forwards the LPDU n to the PHY Layer that performs scrambling and decoding to construct the PPDU n. PPDU n+1 is formed in a similar fashion.

Because asynchronous characters in a Rubicle 88 (e.g., Rubicle i) are available, the PPDU n is mapped onto Rubicles i and i+1. As shown in FIG. 10B, the first fragment of the PPDU n is mapped onto asynchronous characters in Rubicle i on Lane 0. Since the PPDU n cannot be mapped onto asynchronous characters in a Rubicle, the PPDU n is fragmented. The SR control character is appended to the first PPDU n fragment. Next, the second fragment of the PPDU n is mapped onto asynchronous characters in Rubicle i on Lane 1. The third fragment of PPDU n is mapped onto asynchronous characters in Rubicle i+1 on Lane 0. The ER control character is added to the third PPDU fragment. PPDU n+1 mapped onto asynchronous characters available on Rubicle i+1 and i+2 in a similar fashion.

In contrast to the mapping of PPDU n which starts from Lane 0, the mapping of PPDU n+1 starts from Lane 1. Thus, in the serial mapping mode the transmission of PPDU n+1 from the AV transmitter does not begin before the end of transmission of the last fragment of the PPDU n.

The AV receiver recreates the original PPDUs from received packets, and forwards them to the Link Layer. The Link Layer process the LPDUs based on the DA field of the RUBI L2 header once the LPDU passes the CRC check. If more than L lanes are available then the PPDU is mapped onto all Rubicles (asynchronous characters) on the K lanes. For example purposes herein, L is set to 2 (L and K represent the number of lanes available in a given direction). As such, if more lanes are available, then all the available lanes are mapped.

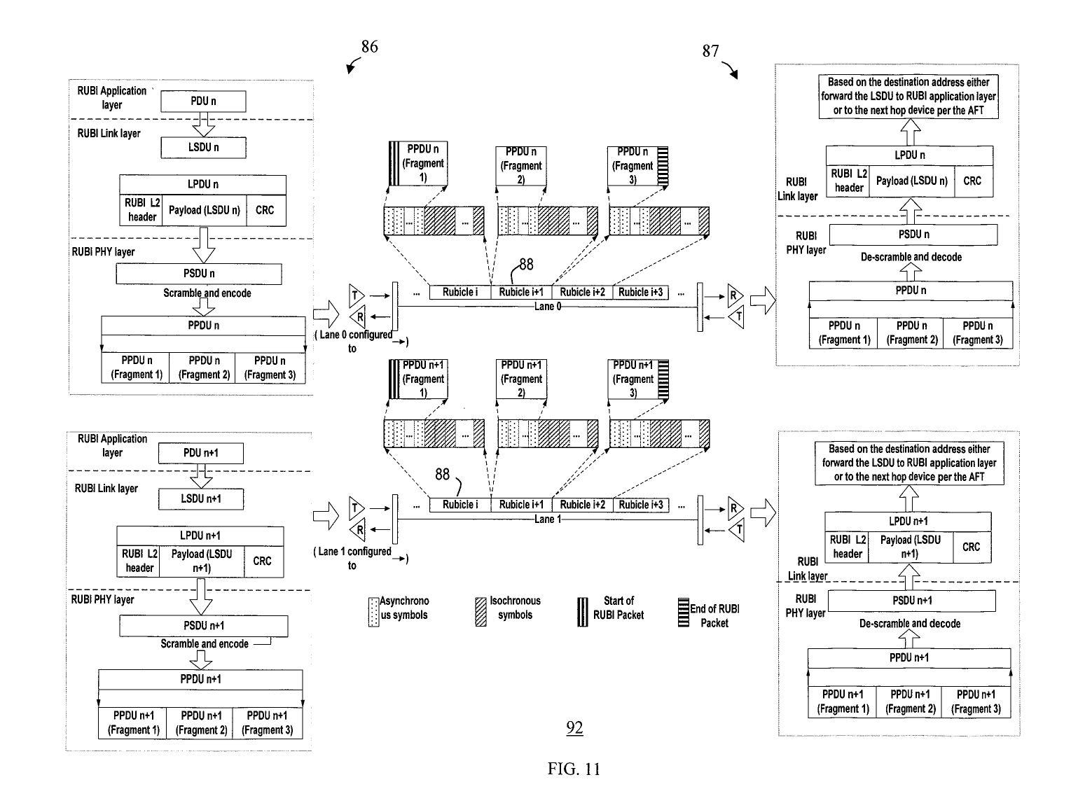

FIG. 11 shows a process 92 for parallel mapping of asynchronous data, according to an embodiment of the invention. In the parallel mapping mode, the PPDU is mapped to Rubicles 88 on the first available lanes. In one example where two lanes (e.g., Lane 0 and Lane 1) are available for the flow, at the AV transmitter 86 the PPDU n is mapped onto Rubicles 88 on the first available lane. In this case, PPDU n is mapped onto Lane 0 in Rubicles i, i+1 and i+2. During the transmission of PPDU n, if PPDU n+1 arrives at the PHY Layer of the AV transmitter then it is mapped onto the next available lane (e.g., Lane 1). The SR and ER characters are inserted in Rubicles to inform the AV receiver 87 of the start and end of the PPDU. The AV receiver 87 reconstructs the PPDU from received packets and performs further processing as in the serial mapping case described in the context of FIGS. 10A-B. In general, L PPDUs can be simultaneously processed if L lanes are available. For illustration purposes herein L is set to 2.

In the above examples shown in FIGS. 10-11, a single LSDU can fit onto the largest size LPDU. When the LSDU cannot fit into the largest size LPDU, then the LSDU is fragmented into multiple LSDUs such that all fragments, except the last LSDU, form the largest size LPDU wherein the last LPDU may be smaller than the largest size LPDU. Said RUBI L2 header includes a fragment control field providing information for the AV receiver for correctly reconstructing the original LSDU after defragmenting the fragmented LSDUs.

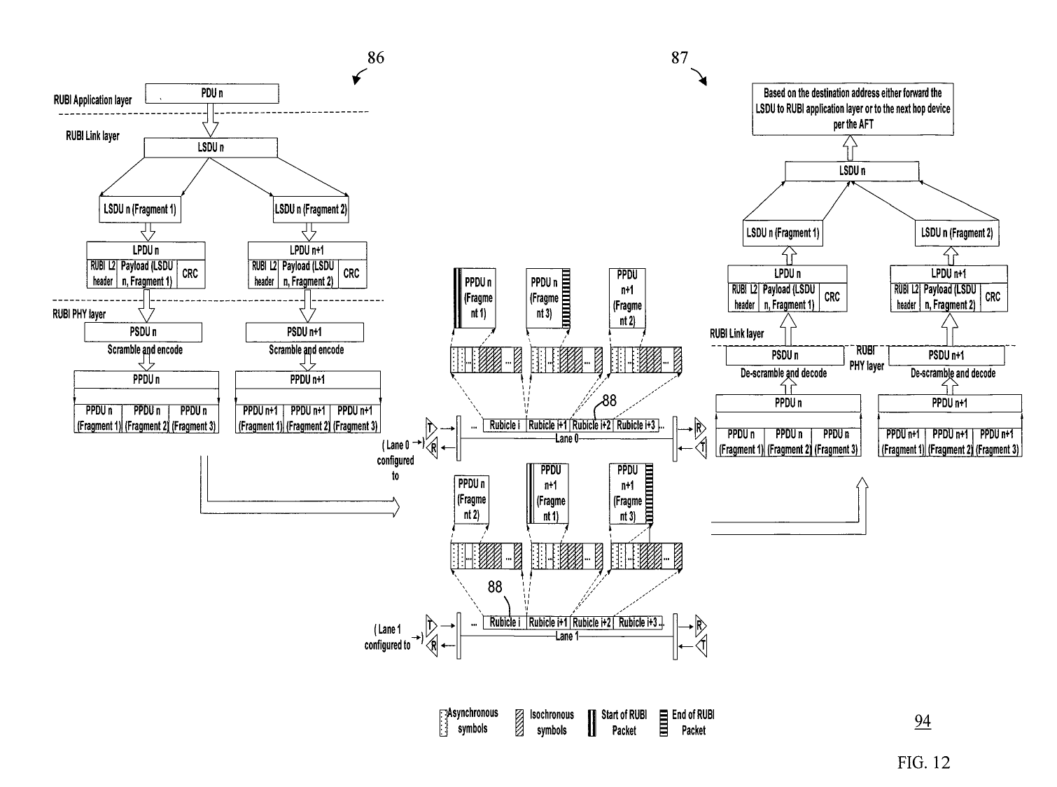

FIG. 12 shows a process 94 for serial mapping of fragmented asynchronous data, according to embodiments of the invention. Specifically, at the AV transmitter 86, the LSDU n is fragmented into two fragments. The first LSDU fragment (Fragment 1) is used to construct the LPDU n and the resulting PPDU n. Similarly, the second LSDU fragment (Fragment 2) is used to construct the LPDU n+1 and the resulting PPDU n+1. The PHY Layer then maps PPDU n onto asynchronous characters in Rubicles i and i+1 starting from Lane 0 to Lane 1. Subsequently, PPDU n+1 is mapped onto asynchronous characters in Rubicles i+1 and i+2 starting from Lane 1 to Lane 0. The AV receiver 87 recreates the PPDU n and PPDU n+1 from received packets, and then recreates original LPDU n and LPDU n+1 after descrambling and decoding of PPDU n and PPDU n+1. The original LSDU is then created after defragmenting LSDU n (Fragment 1) and LSDU n (Fragment 2).

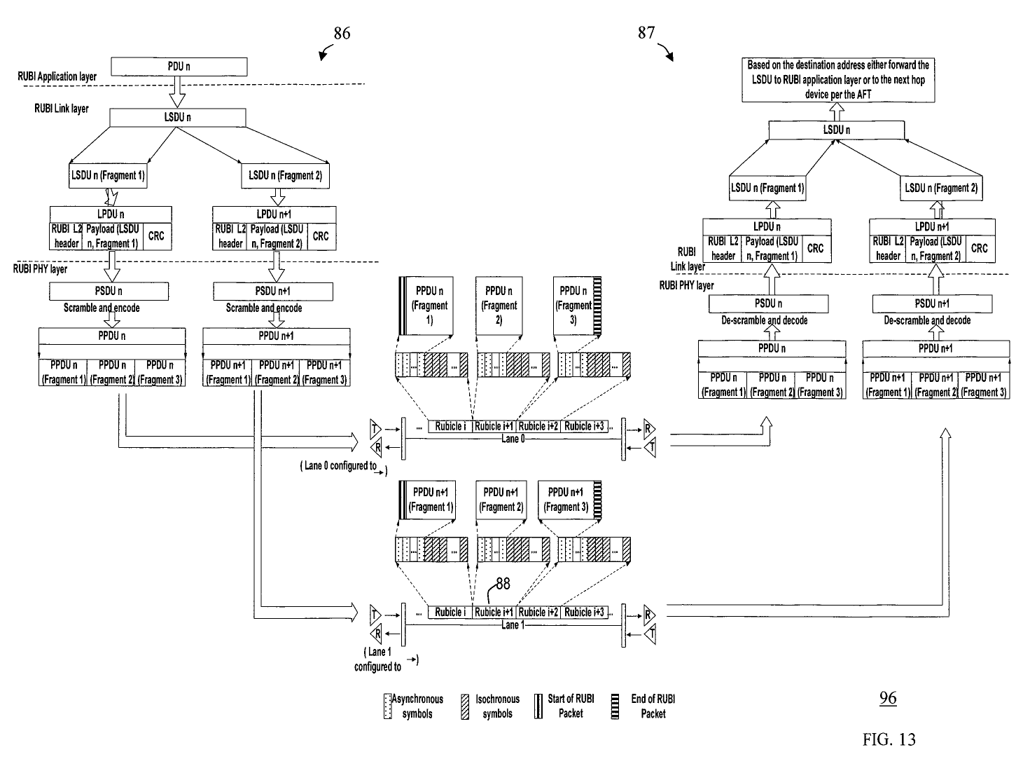

FIG. 13 shows a process 96 for parallel mapping of fragmented asynchronous data according to an embodiment of the invention. Specifically, at the AV transmitter 86, PPDU n and PPDU n+1 are created based on LSDU n (fragment 1) and LSDU n (fragment 2). The PPDU n and PPDU n+1 are mapped in parallel onto Rubicles i, i+1, i+2 on lane 0 and Lane 1, respectively. The AV receiver 87 recreates the LSDU from received packets based similar to the serial mode above.

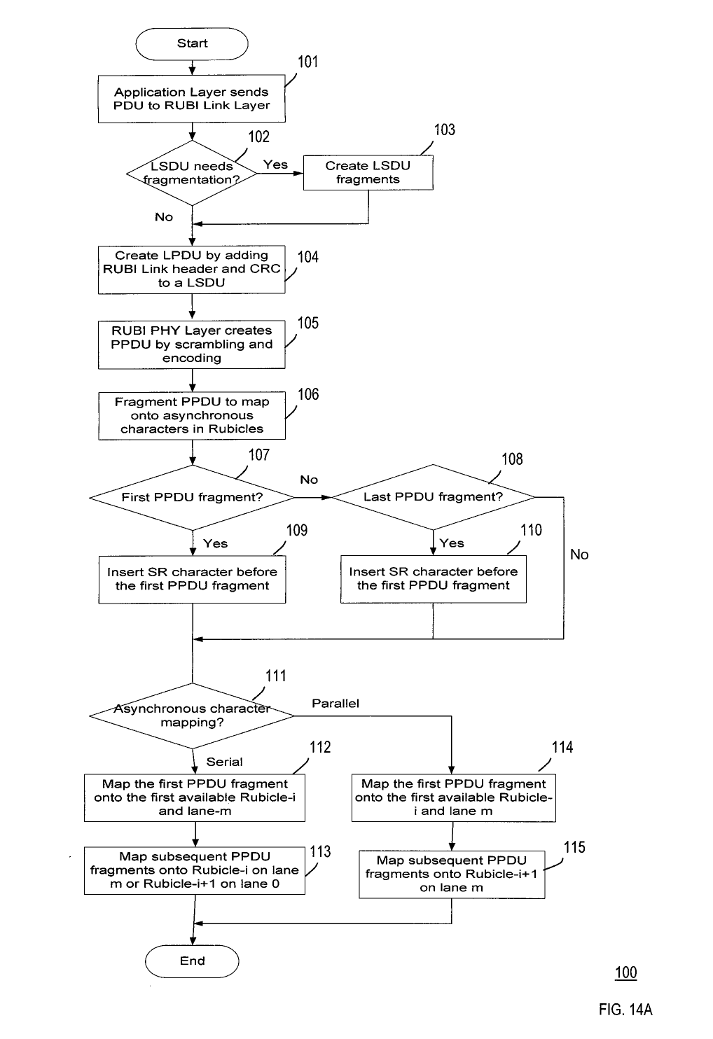

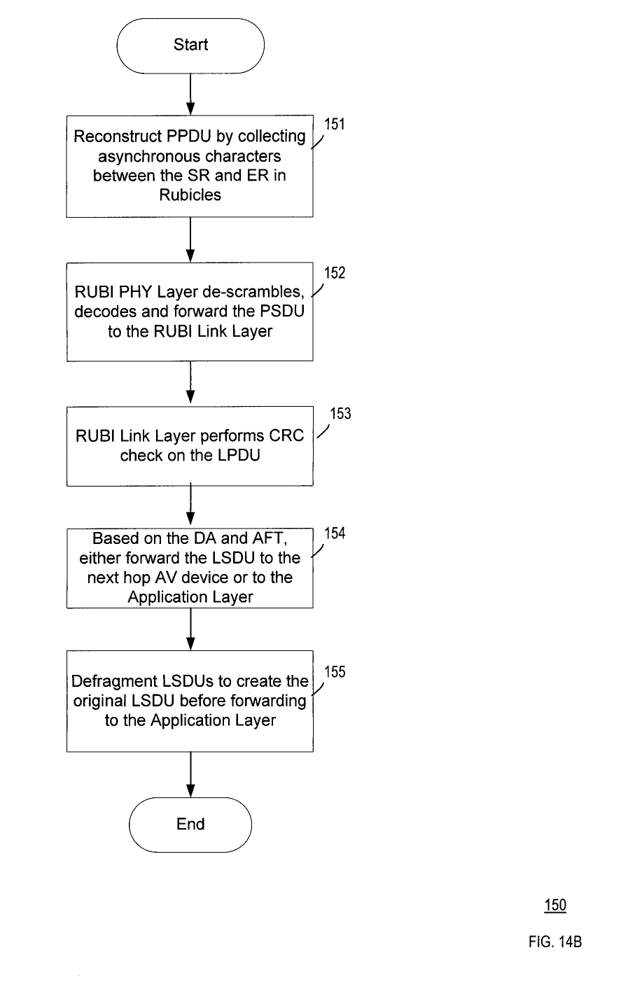

FIG. 14A shows a flowchart of a process 100 implemented by an AV transmitter for multiplexing data communication, according to an embodiment of the invention, comprising the following process blocks:
Block 101: Application Layer sends PDU to RUBI Link Layer.
Block 102: LSDU needs fragmentation? If yes, proceed to block 103, else proceed to block 104.
Block 103: Create LSDU fragments.
Block 104: Create LPDU by adding RUBI Link header and CRC to LSDU.
Block 105: RUBI PHY Layer creates PPDU by scrambling and encoding.
Block 106: Fragment PPDU to map onto asynchronous characters in Rubicles.
Block 107: First PPDU fragment? If no, proceed to block 108, else proceed to block 109.
Block 108: Last PPDU fragment? If yes, proceed to block 110, else proceed to block 111.
Block 109: Insert SR character before the first PPDU fragment. Proceed to block 111.
Block 110: Insert SR character before the first PPDU fragment.
Block 111: Asynchronous character mapping? If yes, proceed to block 112, else proceed to block 114.
Block 112: Map the first PPDU fragment onto the first available Rubicle-i and Lane m.
Block 113: Map subsequent PPDU fragments onto Rubicle-i on Lane m or Rubicle-i+1 on Lane 0. End.
Block 114: Map the first PPDU fragment onto the first available Rubicle-i and Lane m.
Block 115: Map subsequent PPDU fragments onto Rubicle-i+1 on Lane m. End.

FIG. 14B shows a flowchart of a process 150 implemented by an AV receiver for multiplexing data communication, according to an embodiment of the invention, comprising the following process blocks:
Block 151: Reconstruct PPDU by collecting asynchronous characters between the SR and ER in Rubicles.
Block 152: RUBI PHY Layer de-scrambles, decodes and forward the PSDU to the RUBI Link Layer.
Block 153: RUBI Link Layer performs CRC check on the LPDU.
Block 154: Based on the DA and AFT, either forward the LSDU to the next hop AV device or to the Application Layer.
Block 155: Defragment LSDUs to create the original LSDU before forwarding to the Application Layer.

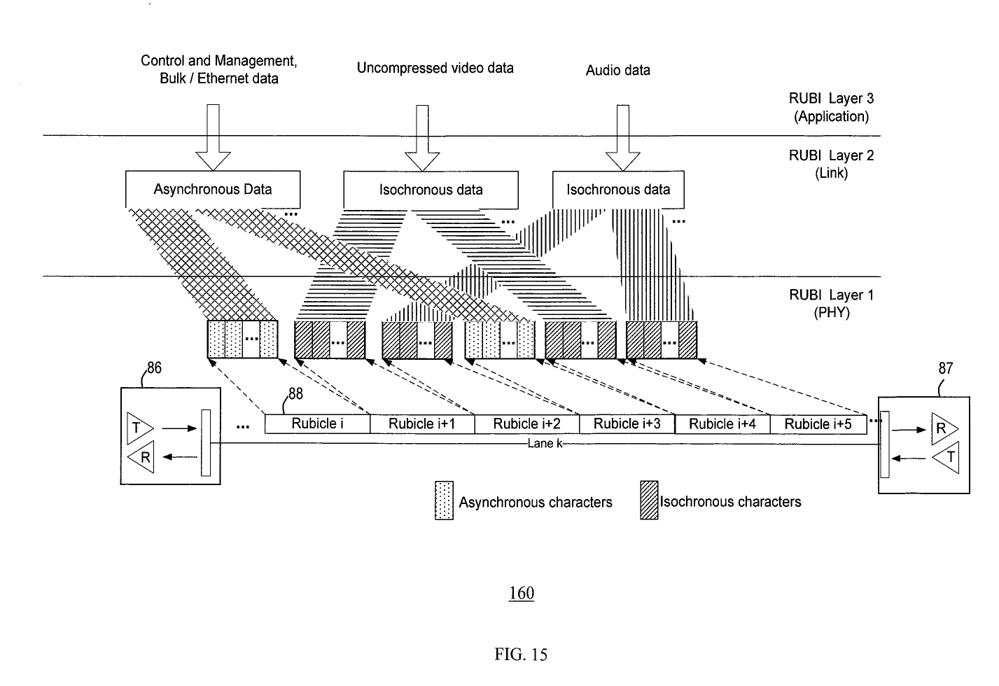

In another embodiment of the invention, the Rubicles carry one type of traffic such as asynchronous or isochronous data. As shown by example process 160 in FIG. 15, in an alternative mapping process each Rubicle 88 is allowed to carry one type of data traffic (either asynchronous characters or isochronous characters).

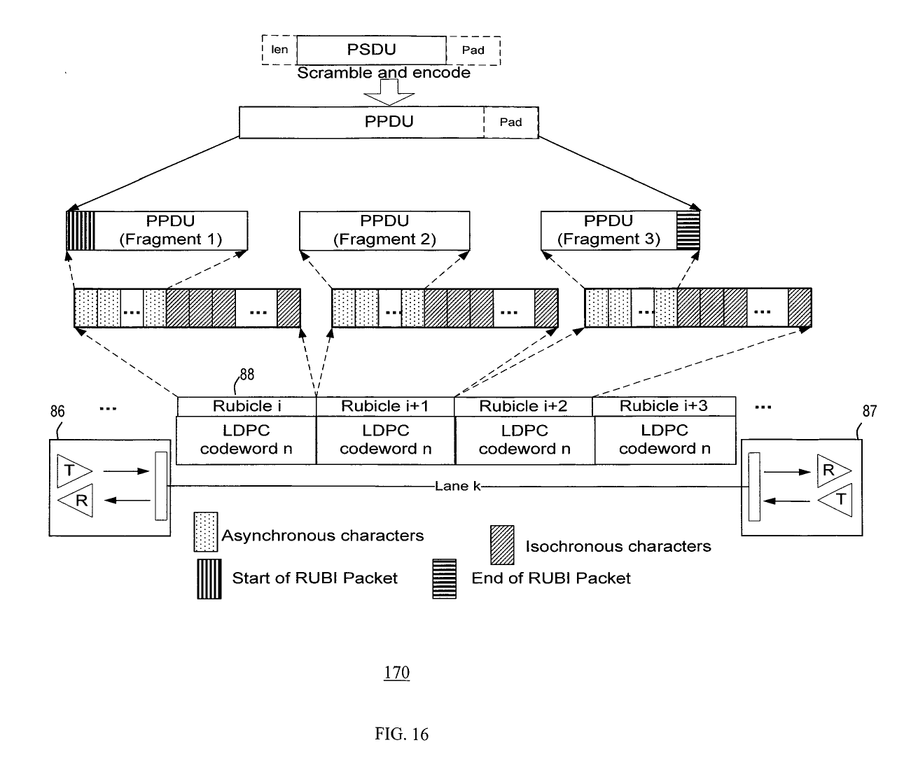

In another embodiment of the invention, multiple isochronous streams multiplex as shown by example process 170 in FIG. 16. The serial and parallel mapping schemes as discussed earlier may be utilized wherein the PPDU carrying asynchronous data is mapped to those Rubicles that carry asynchronous characters. Further, the SR and ER control characters may be utilized to signal the start and end of a (RUBI) packet to the receiver. In one reference embodiment, the Rubicles, which are allowed to carry asynchronous characters, are reserved, a priori. In this case, these Rubicles do not carry any asynchronous data if no PPDU is available for transmission.

The above examples involve ANSI 8b/10b encoding. In other embodiments of the invention, LDPC (low density parity check) may be used as well. In this case, the length of the Rubicles could be an integer number of LDPC codewords. When no data is available for transmission, the Rubicles are filled with zeros. The PSDU may include the length field indicating the length of the PSDU. A few padded bits may be added to the PSDU so that the encoding of the PSDU may map to an integer number of codewords. Based on the length field in the PSDU, the AV receiver can discard these padded bits after descrambling and decoding to obtain the original PSDU. The SR and ER delimiters are a fixed pattern of bits of length 8 or 16-bit. For example, the SR could be a series of 1's. The ER could be a series of 10. FIG. 16 illustrates an example PPDU mapping when instead of ANSI 8b/10, LDPC codewords are used in a RUBI network, according to an embodiment of the invention.

In the example embodiments described in relation to FIGS. 9-16, an AV transmitter can comprise an AV source device or an AV bridge device that selectively forwards information to another AV device. Similarly, an AV receiver can be an AV sink device or an AV bridge device that receives information from an AV device (and may selectively forward the received information to another AV device).

According to the embodiments of the invention, the AV data streaming processes described herein includes transmission of not only video data, but also audio data along with the video data. Embodiments of isochronous data stream management (such as processes described above in relation to in FIGS. 2-5 and FIGS. 6-8) may be implemented as data stream management modules in the MAC layers of the AV devices 11, according to embodiments of the invention Further, embodiments of the communication manager 11X including data multiplexing (such as processes described in conjunction with FIGS. 2-5 and 9-16), may be implemented in the MAC and PHY layers of the AV devices 11, according to embodiments of the invention.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters, receivers, transceivers in wireless networks, etc. Further, embodiments of the invention can take the form of an entirely hardware embodiment, an entirely software embodiment or an embodiment containing both hardware and software elements.

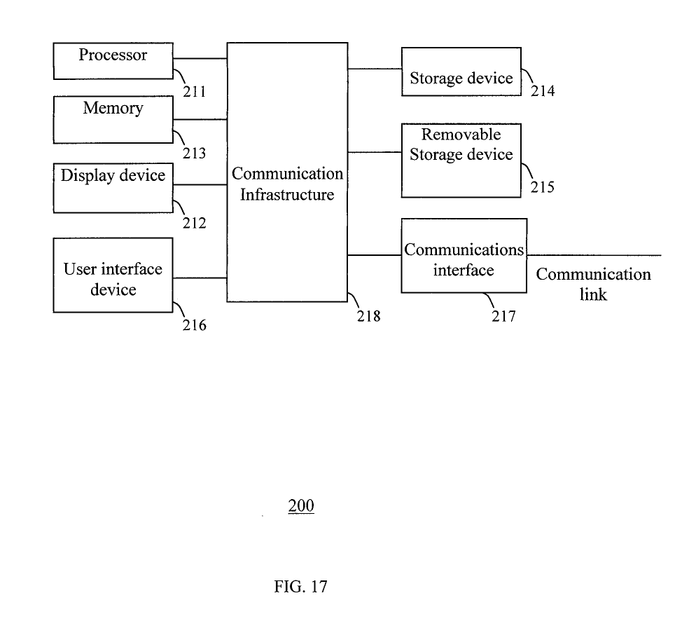

FIG. 17 is a high level block diagram showing an information processing system comprising a computer system 200 useful for implementing an embodiment of the present invention. The computer system 200 includes one or more processors 211, and can further include an electronic display device 212 (for displaying graphics, text, and other data), a main memory 213 (e.g., random access memory (RAM)), storage device 214 (e.g., hard disk drive), removable storage device 215 (e.g., removable storage drive, removable memory module, a magnetic tape drive, optical disk drive, computer readable medium having stored therein computer software and/or data), user interface device 216 (e.g., keyboard, touch screen, keypad, pointing device), and a communication interface 217 (e.g., modem, a network interface (such as an Ethernet card), a communications port, or a PCMCIA slot and card). The communication interface 217 allows software and data to be transferred between the computer system and external devices. The system 200 further includes a communications infrastructure 218 (e.g., a communications bus, cross-over bar, or network) to which the aforementioned devices/modules 211 through 217 are connected.

Information transferred via communications interface 217 may be in the form of signals such as electronic, electromagnetic, optical, or other signals capable of being received by communications interface 217, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of communication between audio/video (AV) devices, comprising:
establishing an AV path stream for AV data streaming between a source AV device and a destination AV device, wherein each AV device includes one or more I/O ports for connecting the AV device to another AV device via a communication link including multiple communication lanes;
multiplexing asynchronous and isochronous AV data for transmission via one or more fixed length data cells, each data cell capable of carrying one or more of: asynchronous data symbols and isochronous data symbols;
wherein multiplexing includes mapping isochronous data onto isochronous symbols in one or more data cells and mapping asynchronous data onto asynchronous symbols in one or more data cells; and
transmitting one or more data cells from a physical layer the source AV device to the destination AV device via one or more communication lanes.

2. The method of claim 1, further comprising continuously transmitting data cells from the source AV device to the destination AV device via one or more communication lanes.

3. The method of claim 2, further comprising:
multiplexing multiple isochronous data streams by mapping the data streams into multiple data cells; and
continually transmitting the isochronous streams via the data cells from the source AV device to the destination AV device on one or more communication lanes.

4. The method of claim 3, wherein:
multiplexing further comprises dynamically mapping asynchronous data into available symbols in the data cells for transmission from the source AV device to the destination AV device on one or more communication lanes.

5. The method of claim 4, wherein the AV data comprises uncompressed video data.

6. The method of claim 4, wherein:
multiplexing further comprises serially mapping data to data cells for transmission on all available lanes in a round-robin manner.

7. The method of claim 4, wherein:
multiplexing further comprises mapping data to data cells in parallel by mapping a data packet to data cells for transmission on an available lane such that all fragments of a data packet are mapped to the same lane.

8. The method of claim 6, wherein:
multiplexing further comprises packet-based asynchronous data multiplexing by fragmenting a physical (PHY) Protocol Data Unit (PPDU) and mapping across one or more data cells at a PHY layer for transmission over one or more communication lanes.

9. The method of claim 8, wherein:
multiplexing further comprises fragmenting a media access control (MAC) Service Data Unit (MSDU) across multiple PPDUs.

10. The method of claim 9, wherein:
multiplexing further comprises serial mapping of PPDUs including asynchronous data to data cells, including:
sending each PPDU to a link layer to generate a Link Service Data Unit (LSDU);
adding a header to the LSDU to generate a Link Protocol Data Unit (LPDU).
wherein the header includes information such as a source address (SA) and a destination address (DA);
forwarding the LPDU to a PHY for scrambling and encoding to generate a PPDU; and
multiplexing by fragmenting a PPDU across multiple data cells for transmission over one or more communication lanes.

11. The method of claim 10, further comprising:
fragmenting a PPDU across multiple data cells for transmission over one or more available communication lanes starting from a first available communication lane configured for transmission; and
fragmenting a subsequent PPDU across multiple data cells for transmission over one or more available communication lanes starting from a second communication lane.

12. The method of claim 7, wherein:
multiplexing further comprises mapping a current PPDU to data cells in parallel by mapping a data packet to data cells for transmission at the PHY layer on an available lane such that all fragments of a data packet are mapped to the same lane; and
upon arrival of a subsequent PPDU during transmission of said current PPDU, mapping the subsequent PPDU onto a next available lane.

13. The method of claim 12, wherein:
multiplexing further comprises mapping fragments of multiple PPDUs in parallel onto multiple data cells on multiple lanes.

14. The method of claim 4, wherein:
multiplexing further comprises utilizing an isochronous forwarding table to determine reserved symbols in a data cell for isochronous streaming.

15. The method of claim 14, wherein:
multiplexing further comprises sub-grouping of reserved symbols and unreserved symbols in a data cell.

16. The method of claim 15, wherein:
asynchronous data is mapped onto unreserved symbols and isochronous data is mapped on reserved symbols in a data cell.

17. The method of claim 4, wherein:
each data cell carries one type of data traffic as asynchronous or isochronous data.

18. The method of claim 12, further comprising:
reconstructing a PPDU by collecting asynchronous data from received data cells.

19. The method of claim 17, wherein said header further includes a fragment control field providing information for the AV receiver for correctly reconstructing a LSDU upon defragmenting the fragmented LSDUs.

20. The method of claim 13, further comprising:
reconstructing a LSDU by collecting asynchronous data from received data cells.

21. The method of claim 1, wherein each AV device includes multiple I/O ports for connecting the AV device to other AV devices.

22. The method of claim 8 wherein:
mapping the PPDU further includes adding a start-of-packet (SR) control character to the beginning of the PPDU data, wherein the SR control character is transmitted before transmission of the first data symbol of the PPDU.

23. The method of claim 22, wherein mapping the PPDU further comprises adding an end-of-packet (ER) control character to the end of the PPDU data.

24. An audio/video (AV) streaming system, comprising:
a switched network of AV devices serially connected via communication links;
wherein at least one of said AV devices comprises:
a connection set-up module that establishes an AV path stream for AV data streaming between a source AV device and a destination AV device, wherein each AV device includes one or more I/O ports for connecting the AV device to another AV device via a communication link including multiple communication lanes; and
a mapping module that multiplexes asynchronous and isochronous AV data for transmission via one or more fixed length data cells at a physical (PHY) layer configured for communicating one or more data cells from the source AV device to the destination AV device via one or more communication lanes, wherein each data cell capable of carrying one or more of: asynchronous data symbols and isochronous data symbols;
wherein the mapping module maps isochronous data onto isochronous symbols in one or more data cells and maps asynchronous data onto asynchronous symbols in one or more data cells.

25. The system of claim 24, wherein the physical layer continuously transmits data cells via one or more communication lanes.

26. The system of claim 24, wherein:
the mapping module multiplexes multiple isochronous data streams by mapping the data streams into multiple data cells; and
the physical layer continually transmits the isochronous streams via the data cells on one or more communication lanes.

27. The system of claim 26, wherein:
the mapping module dynamically maps asynchronous data into available symbols in the data cells for transmission from the source AV device to the destination AV device on one or more communication lanes.

28. The system of claim 27, wherein the AV data comprises uncompressed video data and audio data.

29. The system of claim 27, wherein:
the mapping module serially maps data to data cells for transmission on all available lanes in a round-robin manner.

30. The system of claim 27, wherein:
the mapping module maps data to data cells in parallel by mapping a data packet to data cells for transmission on an available lane such that all fragments of a data packet are mapped to the same lane.

31. The system of claim 29, wherein:
the mapping module performs packet-based asynchronous data multiplexing by fragmenting a PHY Protocol Data Unit (PPDU) and mapping across one or more data cells at a PHY layer for transmission over one or more communication lanes.

32. The system of claim 31, wherein:
the mapping module fragments a media access control (MAC) Service Data Unit (MSDU) across multiple PPDUs.

33. The system of claim 32, wherein:
the mapping module performs serial mapping of PPDUs including asynchronous data to data cells, by:
sending each PPDU to a link layer to generate a Link Service Data Unit (LSDU);
adding a header to the LSDU to generate a Link Protocol Data Unit (LPDU);
wherein the header includes information such as a source address (SA) and a destination address (DA);
forwarding the LPDU to a PHY for scrambling and encoding to generate a PPDU; and
multiplexing by fragmenting a PPDU across multiple data cells for transmission over one or more communication lanes via the PHY layer.

34. The system of claim 33, wherein:
the mapping module fragments a PPDU across multiple data cells for transmission over one or more available communication lanes starting from a first available communication lane configured for transmission; and
the mapping module fragments a subsequent PPDU across multiple data cells for transmission over one or more available communication lanes starting from a second communication lane.

35. The system of claim 30, wherein:
the mapping module maps a current PPDU to data cells in parallel by mapping a data packet to data cells for transmission at the PHY layer on an available lane such that all fragments of a data packet are mapped to the same lane, and upon arrival of a subsequent PPDU during transmission of said current PPDU, the mapping module maps the subsequent PPDU onto a next available lane.

36. The system of claim 35, wherein:
the mapping module maps fragments of multiple PPDUs in parallel onto multiple data cells on multiple lanes.

37. The system of claim 27, wherein:
the mapping module utilizes an isochronous forwarding table to determine reserved symbols in a data cell for isochronous streaming.

38. The system of claim 37, wherein:
the mapping module sub-groups reserved symbols and unreserved symbols in a data cell.

39. The system of claim 38, wherein:
the mapping module maps asynchronous data onto unreserved symbols and maps isochronous onto reserved symbols in a data cell.

40. The system of claim 27, wherein:
each data cell carries one type of data traffic as asynchronous or isochronous data.

41. The system of claim 35, wherein:
a reconstruction module at the AV receiver reconstructs a PPDU by collecting asynchronous data from received data cells.

42. The system of claim 40, wherein said header further includes a fragment control field providing information for the AV receiver for correctly reconstructing a LSDU upon defragmenting the fragmented LSDUs.

43. The system of claim 40, wherein:
a reconstruction module at the AV receiver reconstructs a LSDU by collecting asynchronous data from received data cells.

44. The system of claim 31, wherein:
the mapping module maps the PPDU by adding a start-of-packet (SR) control character to the beginning of the PPDU data, wherein the SR control character is transmitted before transmission of the first data symbol of the PPDU.

45. The system of claim 44, the mapping module maps the PPDU by adding an end-of-packet (ER) control character to the end of the PPDU data.

46. An audio/video (AV) device, comprising:
a connection set-up module that establishes an AV path stream for AV data streaming between a source AV device and a destination AV device, wherein each AV device includes one or more I/O ports for connecting the AV device to another AV device via a communication link including multiple communication lanes;
a mapping module that multiplexes asynchronous and isochronous AV data for transmission via one or more fixed length data cells at a physical (PHY) layer configured for communicating one or more data cells from the source AV device to the destination AV device via one or more communication lanes, wherein each data cell capable of carrying one or more of: asynchronous data symbols and isochronous data symbols;
wherein the mapping module maps isochronous data onto isochronous symbols in one or more data cells and maps asynchronous data onto asynchronous symbols in one or more data cells;
between the source AV device and the destination AV device in a switched network of AV devices.

47. The AV device of claim 46, wherein the physical layer continuously transmits data cells via one or more communication lanes.

48. The AV device of claim 47, wherein:
the mapping module multiplexes multiple isochronous data streams by mapping the data streams into multiple data cells; and
the physical layer continually transmits the isochronous streams via the data cells on one or more communication lanes.

49. The AV device of claim 48, wherein:
the mapping module dynamically maps asynchronous data into available symbols in the data cells for transmission from the source AV device to the destination AV device on one or more communication lanes.

50. The AV device of claim 49, wherein the AV data comprises uncompressed video data and audio data.

51. The AV device of claim 49, wherein:
the mapping module serially maps data to data cells for transmission on all available lanes in a round-robin manner.

52. The AV device of claim 49, wherein:
the mapping module maps data to data cells in parallel by mapping a data packet to data cells for transmission on an available lane such that all fragments of a data packet are mapped to the same lane.

53. The AV device of claim 51, wherein:
the mapping module performs packet-based asynchronous data multiplexing by fragmenting a PHY Protocol Data Unit (PPDU) and mapping across one or more data cells at a PHY layer for transmission over one or more communication lanes.

54. The AV device of claim 53, wherein:
the mapping module fragments a media access control (MAC) Service Data Unit (MSDU) across multiple PPDUs.

55. The AV device of claim 54, wherein:
the mapping module performs serial mapping of PPDUs including asynchronous data to data cells, by:
sending each PPDU to a link layer to generate a Link Service Data Unit (LSDU);
adding a header to the LSDU to generate a Link Protocol Data Unit (LPDU);
wherein the header includes information such as a source address (SA) and a destination address (DA);
forwarding the LPDU to a PHY for scrambling and encoding to generate a PPDU; and
multiplexing by fragmenting a PPDU across multiple data cells for transmission over one or more communication lanes via the PHY layer.

56. The AV device of claim 55, wherein:
the mapping module fragments a PPDU across multiple data cells for transmission over one or more available communication lanes starting from a first available communication lane configured for transmission; and
the mapping module fragments a subsequent PPDU across multiple data cells for transmission over one or more available communication lanes starting from a second communication lane.

57. The AV device of claim 52, wherein:
the mapping module maps a current PPDU to data cells in parallel by mapping a data packet to data cells for transmission at the PHY layer on an available lane such that all fragments of a data packet are mapped to the same lane, and upon arrival of a subsequent PPDU during transmission of said current PPDU, the mapping module maps the subsequent PPDU onto a next available lane.

58. The AV device of claim 57, wherein:
the mapping module maps fragments of multiple PPDUs in parallel onto multiple data cells on multiple lanes.

59. The AV device of claim 49, wherein:
the mapping module utilizes an isochronous forwarding table to determine reserved symbols in a data cell for isochronous streaming.

60. The AV device of claim 59, wherein:
the mapping module sub-groups reserved symbols and unreserved symbols in a data cell.

61. The AV device of claim 60, wherein:
the mapping module maps asynchronous data onto unreserved symbols and maps isochronous onto reserved symbols in a data cell.

62. The AV device of claim 49, wherein:
each data cell carries one type of data traffic as asynchronous or isochronous data.

63. The AV device of claim 62, wherein said header further includes a fragment control field providing information for the AV receiver for correctly reconstructing a LSDU upon defragmenting the fragmented LSDUs.

64. The AV device of claim 53, wherein:
the mapping module maps the PPDU by adding a start-of-packet (SR) control character to the beginning of the PPDU data, wherein the SR control character is transmitted before transmission the first data symbol of the PPDU.

65. The AV device of claim 64, the mapping module maps the PPDU by adding an end-of-packet (ER) control character to the end of the PPDU data.
